(19) United States
(12) Patent Application Publication
(10) Pub. No.: US 2026/0228071 A1
(43) Pub. Date: Aug. 6, 2026

(54) DATA ANALYTICS FOR PREDICTIVE MAINTENANCE

(71) Applicant: PACIFIC GAS AND ELECTRIC COMPANY, Oakland, CA (US)

(72) Inventors: Devon Yates, Boulder, CO (US); John-Peter Dolphin, San Francisco, CA (US); Eric Schoenman, San Francisco, CA (US); Louis William McFaul, IV, Albany, CA (US); Maryam Variani, Walnut Creek, CA (US); Sabrin Mohamed, Alameda, CA (US); Aayushi Gupta, Sunnyvale, CA (US); Shane Buck, Sunnyvale, CA (US); Ana Maria Nungo, Pleasant Hill, CA (US); Charles Scoma, III, Walnut Creek, CA (US); Gamil Ahmed Bahlas, Sacramento, CA (US); Rebecca Harcourt, Denver, CO (US); Sandeep Kataria, Fremont, CA (US)

(21) Appl. No.: 19/631,722

(22) Filed: Mar. 27, 2026

Related U.S. Application Data
(63) Continuation-in-part of application No. 18/133,670, filed on Apr. 12, 2023, now Pat. No. 12,596,364.
(60) Provisional application No. 63/330,032, filed on Apr. 12, 2022.

(51) Int. Cl. G06F 11/00

(52) U.S. Cl. CPC G06F 11/004; G06F 2201/81

(57) ABSTRACT

In some embodiments, systems and methods described herein are directed to predicting asset failure and classifying failure modes in an electrical distribution system. In some embodiments, the system receives meter data from one or more electrical meters and associates the meter data with an asset to create asset data. In some embodiments, an AI model comprises a failure prediction model that determines a probability of failure based on the asset data, and a failure mode classification model that determines a predicted root cause classification based on the asset data. In some embodiments, the failure mode classification model receives the probability of failure from the failure prediction model for determining the predicted root cause classification. In some embodiments, the asset comprises a transformer in the electrical distribution system.

### CROSS-REFERENCE TO RELATED APPLICATION

This application is a Continuation-in-Part of U.S. Patent Application No. 18/133,677, filed April 12, 2023, entitled “DATA ANALYTICS FOR PREDICTIVE MAINTENANCE ,” which claims the benefit of priority from U.S. Provisional Application No. 63/330,032, filed April 12, 2022, entitled “DATA ANALYTICS FOR PREDICTIVE MAINTENANCE ,” the entire contents of which are incorporated herein by reference.

### BACKGROUND

A utility’s approach to asset management impacts reliability of service, system affordability, and a company’s risk profile. The approach that has dominated the utility industry for decades is “emergency outage restoration” - essentially waiting for equipment failure and responding as quickly as possible once failure occurs. This approach aims to minimize near term costs that are passed on to customers through the utilization of an asset through its entire life. A helpful analogy for emergency outage restoration would be replacing a tire on your car only after it goes flat. While this maximizes the life of the tire, it can lead to an unscheduled inconvenience, and the act of the tire going flat can put the occupants of the vehicle at risk. Further, if a tow truck is required, those costs are typically far more expensive than simply replacing the tire before being at risk of a flat. Similarly, waiting for utility equipment failure can increase risk and expense.

Allowing electrical components to run to failure may present an environmental risk. A fire from a utility component such as an electrical transformer may spread to surrounding foliage. Electrical distribution systems have various components that could be a source of ignition upon failure. In a worst-case scenario, an ignition resulting from component failure could possibly lead to a wildfire. Identification of these at-risk assets before failure would be beneficial to reduce the chances of these undesirable events. However, predicting a utility component’s imminent failure has not been possible in the past.

The utility industry has adopted “scheduled maintenance” and “condition-based maintenance” approaches, both of which further reduce risk when compared to emergency outage restoration. However, all conventional maintenance techniques either cost the utility company extra money by taking an asset out of service before the end of its useful life or by allowing components to fail which can interrupt electrical utility service and may create various risks.

Therefore, there is a need in the art for a system and method for using sensor data and advanced analytics to identify signs of imminent failure to extend service life without allowing equipment failure.

### SUMMARY

In some embodiments, the disclosure is direct to systems and methods (generally referred to as the system) for predicting asset failure in an electrical distribution system. In some embodiments, the system comprises one or more of one or more assets, one or more electrical meters, and one or more data analytics platforms. In some embodiments, the system includes one or more computers comprising one or more processors and one or more non-transitory computer readable media, the one or more non-transitory computer readable media include program instructions stored thereon that when executed cause the one or more computers to execute one or more program steps. In some embodiments, a step includes to receive, by the one or more processors, meter data from the one or more electrical meters. In some embodiments, a step includes to associate, by the one or more processors, the meter data with the asset to create asset data. In some embodiments, a step includes to analyze, by the data analytics platform, the asset data. In some embodiments, a step includes to return, by the data analytics platform, a failure prediction model of the asset based on the asset data.

In some embodiments, the meter data comprises voltage. In some embodiments, the one or more non-transitory computer readable media include program instructions stored thereon that when executed cause the one or more computers to select, by the one or more processors, at least one of the one or more electrical meters with a highest voltage. In some embodiments, a step includes to assign, by the one or more processors, at least one of the one or more electrical meters with the highest voltage as at least part of the asset data. In some embodiments, a step includes to exclude, by the one or more processors, at least one of the one or more electrical meters with a voltage lower than the highest voltage from the asset data.

In some embodiments, the one or more non-transitory computer readable media include program instructions stored thereon that when executed cause the one or more computers to send, by the one or more processors, the failure prediction model to an artificial intelligence (AI) model. In some embodiments, the AI model is configured to determine if the asset will fail based on a comparison to previous failure prediction models. In some embodiments, a step includes to receive, by the AI model, a plurality of failure prediction models. In some embodiments, a step includes to generate, by the AI model, a failure designation for each of the plurality of failure prediction models.

In some embodiments, the system comprises one or more of a first asset, a first electrical meter, a second asset, a second electrical meter, an artificial intelligence (AI) model. In some embodiments, the one or more non-transitory computer readable media include program instructions stored thereon that when executed cause the one or more computers to receive, by the one or more processors, first meter data from the first electrical meter. In some embodiments, a step includes to associate, by the one or more processors, the first meter data with a first asset to create first asset data. In some embodiments, a step includes to receive, by the one or more processors, second meter data from a second electrical meter. In some embodiments, a step includes to associate, by the one or more processors, the second meter data with a second asset to create second asset data. In some embodiments, a step includes to send, by the one or more processors, the first asset data and the second asset data to the AI model.

In some embodiments, the one or more non-transitory computer readable media include program instructions stored thereon that when executed further cause the one or more computers to generate, by the one or more processors, a graphical user interface (GUI) comprising an input configured to enable a user to designate the first asset data as a match or a non-match for a condition. In some embodiments, a step includes to receive, by the one or more processors, a first asset designation comprising a designation by the user of the first asset as a first match or a first non-match for the condition. In some embodiments, sending the first asset data and the second asset data to the AI model includes sending the first asset designation. In some embodiments, the first asset data and the second asset data are used to train the AI model.

In some embodiments, the one or more non-transitory computer readable media include program instructions stored thereon that when executed further cause the one or more computers to output, by the AI model, a first asset designation comprising a first designation of the first asset as a first match or a first non-match for a condition. In some embodiments, a step includes to output, by the AI model, a second asset designation comprising a second designation of the second asset as a second match or a second non-match for the condition. In some embodiments, a step includes to generate, by the one or more processors, a graphical user interface comprising at least one of the first asset designation and the second asset designation. In some embodiments, a step includes to generate, by the one or more processors, an input for changing at least one of the first asset designation and the second asset designation. In some embodiments, a step includes to receive, by the one or more processors, a changed designation comprising a change of at least one of the first asset designation and the second asset designation. In some embodiments, a step includes to send, by the one or more processors, the changed designation to the AI model to improve a decision analysis of the AI model.

In some embodiments, the system includes a data analytics platform. In some embodiments, the one or more non-transitory computer readable media include program instructions stored thereon that when executed further cause the one or more computers to determine, by the data analytics platform, a life expectancy of the first asset based on the first asset data.

In some embodiments, the disclosure is directed to a method for creating an artificial intelligence model to predict asset failure in an electrical distribution system. In some embodiments, a step includes receiving first meter data from a first electrical meter. In some embodiments, a step includes associating the first meter data with a first asset to create first asset data. In some embodiments, a step includes receiving second meter data from a second electrical meter. In some embodiments, a step includes associating the second meter data with a second asset to create second asset data. In some embodiments, a step includes designating the first asset data as a first match or a first non-match for a condition. In some embodiments, a step includes sending the first asset data and the second asset data to an artificial intelligence (AI) model as a training set.

In some embodiments, a step includes outputting a result of a decision analysis by the AI model. In some embodiments, the results comprise a match designation or a non-match designation for the condition for the second asset. In some embodiments, a step includes generating a graphical user interface comprising the result. In some embodiments, a step includes generating an input for changing the result to create a changed result. In some embodiments, a step includes sending the changed result to the AI model to improve the decision analysis.

In some embodiments, a step includes creating a plurality of asset data by associating meter data from one or more meters to each of a plurality of assets. In some embodiments, a step includes sending the plurality of asset data to the AI model for a decision analysis. In some embodiments, a step includes outputting results of the decision analysis, the results comprising a match designation or a non-match designation for the condition for each of the plurality of assets.

In some embodiments, a step includes generating a graphical user interface comprising at least one of the results. In some embodiments, a step includes generating an input for changing at least one of the results to create a changed result. In some embodiments, a step includes sending the changed result to the AI model to improve the decision analysis. In some embodiments, the decision analysis includes a transformer failure prediction. In some embodiments, the plurality of assets includes at least one transformer. In some embodiments, the first asset and/or second asset comprises a transformer.

In some embodiments, the AI model described herein comprises one or more sub-models, each configured to perform a specific analytical task using the asset data. In some embodiments, the one or more sub-models include a failure prediction model configured to determine a probability of failure for an asset, and a failure mode classification model configured to classify a predicted or confirmed failure into one or more root cause categories. In some embodiments, the failure prediction model and the failure mode classification model are trained independently, but execute as part of the AI model pipeline. In some embodiments, the failure prediction model and the failure mode classification model share one or more features from the asset data as inputs. In some embodiments, the failure prediction model and the failure mode classification model operate sequentially, in parallel, or in combination, as further described herein.

In some embodiments, the system comprises an asset, one or more electrical meters, an AI model comprising a failure prediction model, and one or more computers comprising one or more processors and one or more non-transitory computer readable media. In some embodiments, the one or more non-transitory computer readable media include program instructions stored thereon that when executed cause the one or more computers to receive meter data from the one or more electrical meters. Some embodiments include a step to associate the meter data with the asset to create asset data. Some embodiments include a step to determine, by the failure prediction model, a probability of failure of the asset based on the asset data.

In some embodiments, the system is configured to determine, by the failure mode classification model, a predicted root cause classification of the asset based on the asset data. In some embodiments, the failure mode classification model is configured to receive the probability of failure from the failure prediction model before determining the predicted root cause classification.

In some embodiments, the predicted root cause classification includes one or more root cause categories. In some embodiments, the one or more root cause categories comprise one or more of windings failure, loose neutral, overloading, energy theft, ignition failure, and heatwave failure. In some embodiments, the failure mode classification model receives the asset data for the asset after the failure prediction model determines the probability of failure exceeds a threshold.

In some embodiments, the system is configured to generate a graphical user interface displaying the predicted root cause classification. In some embodiments, the system is configured to receive a user correction to the predicted root cause classification via the graphical user interface. In some embodiments, the system is configured to send the user correction to the failure mode classification model to improve classification accuracy.

In some embodiments, the system is configured to combine the probability of failure with the predicted root cause classification to generate a composite priority score. In some embodiments, the probability of failure includes an insulation degradation assessment. In some embodiments, the insulation degradation assessment is based on an aggregated loading percentage, one or more temperature-related features, and/or a transformer age.

In some embodiments, the asset data includes a number of consecutive days during which ambient temperature exceeds a specified threshold. In some embodiments, the asset data includes an estimated air conditioning demand based on an average daily temperature. In some embodiments, the asset includes a transformer. In some embodiments, the asset data includes a geographic designation denoting the location of transformer. In some embodiments, the failure prediction model is trained with transformer data labeled as failure or non-failure. In some embodiments, the failure mode classification model is trained with transformer data labeled with a root cause designation.

### DRAWINGS DESCRIPTION

FIG. 1 illustrates neighboring transformers on an electrical utility grid.

FIG. 2 illustrates a non-limiting example of training data according to some embodiments.

FIG. 3 depicts calibration data according to some embodiments.

FIG. 4 shows a flowchart for a method of implementing corrective action for various types of identified anomalies according to some embodiments.

FIG. 5 shows a modeling process flow according to some embodiments.

FIG. 6 illustrates a non-limiting example of transformer failure model steps according to some embodiments.

FIGS. 7-28 illustrate a non-limiting system implementation overview including various system configurations and implemented steps according to some embodiments.

FIG. 7 includes an overview of the California Epic program according to some embodiments.

FIG. 8 shows an electrical distribution system suitable for implementation of the system according to some embodiments.

FIG. 9 shows steps for system implementation and refinement by a utility according to some embodiments.

FIG. 10 shows the system implemented as part of a Community Wildfire Safety Program (CWSP) according to some embodiments.

FIG. 11 illustrates the analogy of using aspects of the system as a “check engine light” according to some embodiments.

FIG. 12 shows the system’s data-drive asset strategy enablement according to some embodiments.

FIG. 13 illustrates a predictive maintenance strategy according to some embodiments.

FIG. 14 shows asset (component) analytics timeframes dependent on available data types according to some embodiments.

FIG. 15 shows the phenomena of data resolution impact on observability of near real-time distribution system anomalies according to some embodiments.

FIG. 16 shows the failure modes of data resolution’s impact on observability of near real-time distribution system anomalies according to some embodiments.

FIG. 17 shows the system’s focus on electrical service transformers and not substation transformers according to some embodiments.

FIG. 18 illustrates how the system targets failures manifesting in AMI voltage anomalies according to some embodiments.

FIG. 19 illustrates steps for implementing a supervised system machine learning process according to some embodiments.

FIG. 20 shows various subsystems that the system uses to collect data inputs according to some embodiments.

FIG. 21 shows system predictive analytics development and implementation process steps for transformers according to some embodiments.

FIG. 22 depicts a map of utility asset voltage distribution according to some embodiments.

FIG. 23 shows how service transformer failure manifests in AMI voltage data according to some embodiments.

FIG. 24 illustrates how transform failure logic implementation is a complex problem with many variables in some embodiments.

FIG. 25 shows a model and use case development according to some embodiments.

FIG. 26 shows how the system provides the benefit of reducing wildfire risk, unplanned outage cost, and customer claims according to some embodiments.

FIG. 27 depicts system data quality challenges and mitigations according to some embodiments.

FIG. 28 shows a system asset data foundation concept according to some embodiments.

FIGS. 29-41 depict data analytics executed by the system for predictive maintenance according to some embodiments.

FIG. 29 shows one or more components of the system’s data analytics platform according to some embodiments.

FIG. 30 illustrates one or more system steps and inputs for identifying incipient failures according to some embodiments.

FIG. 31 list various benefits provided by the system’s predictive maintenance implementation according to some embodiments.

FIG. 32 shows a diagram of some assets (components) and terms used in the system according to some embodiments.

FIG. 33 shows system objectives for initial implementations by a utility according to some embodiments.

FIG. 34 illustrates how a model is developed and benchmarked with voltage anomaly features according to some embodiments.

FIG. 35 shows finding ground truth in different phase implementations of the system according to some embodiments.

FIG. 36 shows steps for creating an artificial intelligence model according to some embodiments.

FIG. 37 shows system identification of a potential windings failure after a lightning event according to some embodiments.

FIG. 38 shows a system identification of a potential energy theft according to some embodiments.

FIG. 39 shows steps for system implementation and refinement by a utility according to some embodiments.

FIG. 40 shows various subsystems that the system uses to collect data inputs according to some embodiments.

FIG. 41 shows a flowchart for implementing corrective action for various type of identified anomalies according to some embodiments.

FIG. 42 shows a flowchart for creating a transformer incipient failure day labels according to some embodiments.

FIG. 43 illustrates inputting transformer incipient failure day labels for prediction and validation according to some embodiments.

FIG. 44 illustrates filtering and compiling to generate prepared features according to some embodiments.

FIG. 45 shows a computer system 1010 enabling or comprising the systems and methods in accordance with some embodiments of the system.

### DETAILED DESCRIPTION

In some embodiments, the disclosure is directed to systems and methods (the “system”) for using sensor data and advanced analytics to predict imminent failure of a utility asset (e.g., transformer, meter, etc.) in an electrical distribution system. As used herein, a “utility” is an electricity provider that creates, monitors, and/or delivers electricity from an electrical power plant to a business or residence, although the innovations described herein can be used in a wide variety of utility and non-utility systems. As used herein as non-limiting examples, an “asset” is a component of an electrical distribution system, and can include, as non-limiting examples generators, towers, transformers, power lines, computer modules, and/or any conventional equipment associated with a utility.

Predictive maintenance is most akin to a check engine light, which identifies when something in your vehicle is outside of normal operating conditions but has not yet led to your car being inoperable. This approach optimizes all three elements in some embodiments: reliability, affordability, and risk by identifying potential failures before they occur allowing for the re-routing of power or in some cases hot asset replacement (reliability), ensures assets are utilized through their entire useful life (affordability), and stops failures - including those that could lead to wildfire ignitions or other safety incidents - from occurring all together (risk).

In some embodiments, the system includes a predictive failure model that includes at least one or more of the following inputs: smart meter voltage, electric distribution network configuration data, historical smart meter peak and average loading, historical ambient temperature, and historical failure records.

In some embodiments, the system includes artificial intelligence. In some embodiments, artificial intelligence includes a machine learning (ML) classification model that is trained against historical failures to develop a prediction for the probability of equipment failure for a given time frame. In some embodiments, the system includes a data preparation and modelling technique that is unique and novel in that it does not require accurate transformer phase connection information to be effective. In some embodiments, the system is configured and to identify and/or predict one or more different failure modes. In some embodiments, failure modes include, as non-limiting examples, windings failures, loose neutrals, overloading, energy theft, and/or any conventional failure mode of a utility asset. In some embodiments, the system is applicable to utility systems with high amounts of distributed solar generating systems.

In some embodiments, data preparation includes determining nominal voltage levels. In some embodiments, nominal voltage levels are inferred using utility meter form and voltage summary statistics. In some embodiments, the system is configured to normalize smart meter voltages against their nominal voltage levels. In some embodiments, based on the smart meter form, the system is configured to use data quality rules to filter meter failures and irrelevant measurement channels.

In some embodiments, data preparation includes bellwether voltage data. As used herein, bellwether voltage is defined as the representative voltage of one or more transformers upstream and/or downstream from a transformer of interest. In some embodiments, a representative voltage is defined as the voltage of the low side (secondary conductor) of a transformer calculated using voltage readings from smart meters fed by the transformer. In some embodiments, the system is configured to identify a one or more representative meters (e.g., a pair of meters) for a given transformer by finding meters with the highest voltage over a period, and thus the lowest assumed impedance to the transformer. In some embodiments, to avoid selecting meters with highest voltage due to solar generation, the system is configured to identify the highest voltage meters only during peak loading hours when the sun is down.

In some embodiments, meters which have been flagged by the system as potential misassignments are excluded from the analysis. In some embodiments, the system is configured to exclude channels which have statistically significant and/or sustained anomalies from the analysis, such that meter failures and common fuse failures are not included.

In some embodiments, the system includes feature generation. In some embodiments, feature generation includes aggregating one or more of (smart) meter voltage, neighbor (bellwether) transformer voltage features, loading data, and historical temperature data.

In some embodiments, aggregating meter voltage includes configuring the system to aggregate the prepared raw and bellwether smart meter voltage across days. In some embodiments, the system is configured to generate summary statistics across all measurements, such as mean, range and/or any conventional statistics of interest. In some embodiments, the system is configured to send, by one or more processors, the summary statistics to an AI model as training data and/or for prediction.

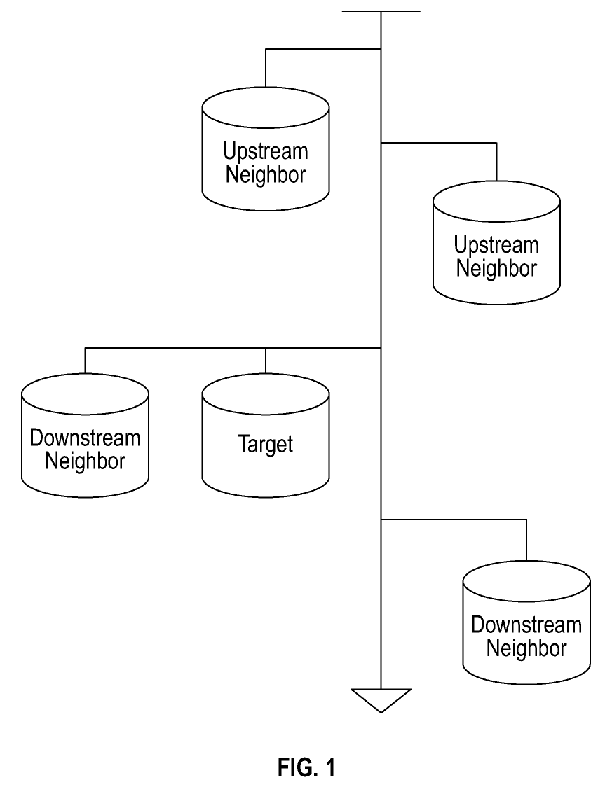

In some embodiments, aggregating certain neighbor (bellwether) transformer voltage features include, for each transformer, configuring the system to identify several other neighbor transformers which are electrically close using utility network configuration information. In some embodiments, the system is configured to only select neighbor transformers that have similar voltage for the aggregation. In some embodiments, the system is configured to use any neighbor transformer regardless of phase for the aggregation. In some embodiments, the system is configured to create summary statistics for upstream and downstream neighboring bellwether voltages for the neighboring transformers. In some embodiments, the system is configured to compare the target transformer voltage to the average upstream transformer bellwether voltages, and the neighbor transformers with the closest voltage measurements. In some embodiments, the use of one or more neighbor transformers and identification of the closest voltage relationship by the system makes it possible for the system to identify anomalies without necessarily having accurate phasing information. FIG. 1 illustrates the concept of neighboring transformers on an electrical utility grid. In some embodiments, the target is the transformer of interest, where one or more smart meters electrically coupled to the upstream and/or downstream neighbor transforms provide the bellwether voltage for the analysis.

In some embodiments, feature generation includes loading data. In some embodiments, the system is configured to collect transformer historical peak and average loading as a percent of seasonal transformer capability for varying periods of time. In some embodiments, the system is configured to use historical peak and average loading to develop features which capture the history of loading on the component.

In some embodiments, the system is configured to receive customer interval loading data from one or more smart meters associated with a transformer or plurality of transformers. In some embodiments, customer interval loading data includes energy consumption data collected at one or more defined intervals, including, as non-limiting examples, 15-minute intervals, hourly intervals, daily intervals, and/or any interval supported by the advanced metering infrastructure (AMI). In some embodiments, the system is configured to retrieve a rated capacity of the transformer from an asset data repository. In some embodiments, the system is configured to calculate a loading percentage at the transformer unit level based on the customer interval loading data and the rated capacity of the transformer. In some embodiments, the loading percentage at the transformer unit level is calculated as the sum of energy consumption from all downstream smart meters associated with the transformer divided by the rated capacity of the transformer. In some embodiments, the loading percentage is expressed as a percentage value.

In some embodiments, the system is configured to aggregate the loading percentage over one or more defined time periods to generate an aggregated loading percentage. In some embodiments, the aggregated loading percentage includes a loading percentage aggregated over a rolling time window, including, as non-limiting examples, a 7-day rolling window, a 30-day rolling window, a 90-day rolling window, and/or any other rolling time window. In some embodiments, the aggregated loading percentage includes a peak loading percentage over a defined period. In some embodiments, the aggregated loading percentage includes an average loading percentage over a defined period. In some embodiments, the aggregated loading percentage includes a distribution or histogram of loading percentages over a defined period. The aggregated loading percentage may include any combination of the foregoing, in accordance with some embodiments.

In some embodiments, the system is configured to combine the aggregated loading percentage with one or more temperature-related features and a transformer age. In some embodiments, temperature-related features include one or more of the temperature summary statistics described herein, the number of consecutive days during which the ambient temperature exceeds a specified threshold, the maximum consecutive day count over a defined historical period, the average daily temperature, and the estimated air conditioning demand, as described herein.

In some embodiments, the system is configured to execute an insulation degradation assessment based on the combination of the aggregated loading percentage, the one or more temperature-related features, and the transformer age. In some embodiments, the insulation degradation assessment serves enables the system to predict transformer insulation degradation. Higher loading increases transformer hotspot temperature which accelerates insulation breakdown; sustained loading over time in combination with elevated ambient temperature and increasing asset age compounds the rate of insulation degradation.

In some embodiments, the insulation degradation assessment includes a degradation score or index calculated by the system using a thermal aging model, where the thermal aging model applies a determined relationship between hotspot temperature, loading, ambient temperature, and time to estimate a rate of insulation deterioration. In some embodiments, the insulation degradation assessment includes a set of combined features, including the aggregated loading percentage, the one or more temperature-related features, and the transformer age, sent to the AI model as inputs, where the AI model learns the degradation relationship from training data including known failures correlated with loading, temperature, and age patterns. In some embodiments, the system is configured to calculate the degradation score using the thermal aging model and send the calculated degradation score to the AI model as an additional feature input alongside the aggregated loading percentage, the one or more temperature-related features, and the transformer age, such that the AI model receives both the raw combined features and the calculated degradation score derived from those features.

In some embodiments, the insulation degradation assessment includes a numerical degradation score or index. In some embodiments, the insulation degradation assessment includes a categorical degradation level, including, as non-limiting examples, low, moderate, high, or critical, where such terms correlate to a timespan where equipment may be damaged. In some embodiments, the insulation degradation assessment includes a remaining insulation life estimate. In some embodiments, the insulation degradation assessment includes an input feature to the failure prediction model that improves prediction accuracy.

In some embodiments, the system is configured to include the insulation degradation assessment as part of the asset data. In some embodiments, the system is configured to send the asset data including the insulation degradation assessment to the AI model for training and/or prediction. In some embodiments, the insulation degradation assessment is included in the asset data sent to the AI model for failure prediction. In some embodiments, the insulation degradation assessment is included in the asset data paired with root cause designations to train the failure mode classification model described herein. In some embodiments, the insulation degradation assessment is included in the asset data sent to the trained failure mode classification model for root cause prediction. This allows the system to exclude variations that fit a pattern model, according to some embodiments.

In some embodiments, feature generation includes historical temperature data. In some embodiments, the system is configured to capture temperature summary statistics using weather reports and/or meteorological towers that are near (e.g., less than 50 miles) a transformer. In some embodiments, the system is configured to correlate the temperature summary statistics to component failure. In some embodiments, the system is configured to generate a seasonal component of failure characteristics using the temperature summary statistics.

Transformer insulation degradation is accelerated by sustained elevated temperatures. A single high-temperature day followed by a cooler day allows the transformer to dissipate accumulated heat: multiple consecutive high-temperature days prevent adequate cooling, causing cumulative thermal stress that is not captured by average or peak temperature alone.

In some embodiments, the system is configured to determine the number of consecutive days during which the ambient temperature exceeds a specified threshold. In some embodiments, the specified threshold comprises a fixed threshold value, including, as non-limiting examples, 95 degrees Fahrenheit or 35 degrees Celsius. In some embodiments, the specified threshold comprises a user-configurable threshold set through a graphical user interface or system configuration. In some embodiments, the specified threshold comprises an asset-specific threshold determined by the system based on a rated operating temperature and/or nameplate data of the transformer. In some embodiments, the specified threshold comprises any combination of the foregoing.

In some embodiments, the system is configured to monitor ambient temperature data received from one or more weather data sources for a geographic area associated with the asset. In some embodiments, the system is configured to determine a number of days when the average daily ambient temperature exceeds the specified threshold for a given day (i.e., 24 hours). Although days are used in this non-limiting example, any desired time period is within the scope of the system. In some embodiments, the system is configured to determine a number of consecutive days when the average ambient temperature exceeds the specified threshold. In some embodiments, the resulting number of consecutive days represents the number of consecutive days the transformer has been exposed to elevated ambient temperature without a cooling opportunity. In some embodiments, the system is configured to determine a maximum consecutive day count over a defined historical period, capturing the worst-case sustained heat exposure the transformer has experienced.

In some embodiments, the monitored average daily temperature is used to estimate air conditioning demand on the transformer. Higher average daily temperatures correlate with increased air conditioning usage by customers served by the transformer, and increased air conditioning usage increases electrical load on the transformer. In some embodiments, the system is configured to generate an estimated air conditioning demand based on the average daily temperature, where the estimated air conditioning demand is used by the system to predict an increase in electrical load attributable to customer cooling equipment. In some embodiments, the estimated air conditioning demand is used to adjust or supplement the loading percentage calculated from customer interval loading data as described herein, such that the system accounts for anticipated load increases that may not yet be reflected in the most recent interval data. In some embodiments, the estimated air conditioning demand is used as an independent feature sent to the AI model separately from the loading percentage.

Consecutive high-temperature days increase both the ambient thermal stress on the transformer and the electrical load from air conditioning demand, creating a compounding effect where the transformer simultaneously experiences both external heating from elevated ambient temperature and internal heating from increased load. In some embodiments, the combination of the number of consecutive days feature and the estimated air conditioning demand captures this compounding effect by providing the AI model with both the duration of sustained thermal exposure and the corresponding load increase driven by that exposure.

In some embodiments, the system is configured to include the number of consecutive days, the maximum consecutive day count, the average daily temperature, and the estimated air conditioning demand as features in the asset data. In some embodiments, the system is configured to send the asset data including the number of consecutive days, the maximum consecutive day count, the average daily temperature, and the estimated air conditioning demand to the AI model for training and/or prediction. In some embodiments, these features are included in the asset data sent to the AI model for failure prediction. In some embodiments, these features are included in the asset data paired with root cause designations to train the failure mode classification model described herein. In some embodiments, these features are included in the asset data sent to the trained failure mode classification model for root cause prediction.

In some embodiments, feature generation includes asset information that characterizes the physical attributes and installation context of the asset. In some embodiments, asset information includes transformer age and geographic designation, which are used alongside the voltage, loading, and temperature features described herein to provide the AI model with a more complete representation of the factors that influence asset degradation and failure.

In some embodiments, the system is configured to retrieve an installation date for the asset from an asset data repository, where the installation date is stored as a component of spatial and/or as-built data in the asset data foundation described herein. In some embodiments, the system is configured to calculate an asset age based on the installation date and a current date. In some embodiments, the asset age is represented as a raw numerical value indicating the elapsed time since installation. In some embodiments, the asset age is represented as a binned or categorical value where the asset is assigned to an age range, including, as non-limiting examples, 0-10 years, 10-20 years, 20-30 years, 30-40 years, and/or any other age range. In some embodiments, the system is configured to provide both the raw numerical value and the binned or categorical value to the AI model as separate features, where the raw numerical value captures the precise age and the binned value enables the AI model to identify failure patterns common to assets within similar age groups.

In some embodiments, the asset age informs multiple aspects of the system's analysis. In some embodiments, the asset age is used as a component of the insulation degradation assessment described herein, where increasing asset age indicates a longer cumulative exposure to thermal and electrical stress on the transformer insulation, and where the combination of asset age with the aggregated loading percentage and one or more temperature-related features enables the system to assess the cumulative effect of operating conditions over the life of the asset. In some embodiments, the asset age is used as a factor in the life expectancy determination described herein, where the system compares the calculated asset age against the expected useful life to assess remaining service time.

In some embodiments, the system is configured to determine a geographic designation indicating whether the asset is installed in a coastal area. In some embodiments, the geographic designation accounts for accelerated corrosion from salt air exposure, which degrades transformer components including bushings, tanks, and connections at a faster rate than inland installations, and which may cause a transformer to reach end of useful life sooner than an equivalent transformer installed in a non-coastal area. In some embodiments, the system is configured to retrieve the geographic designation from the asset data repository, where the geographic designation was assigned during asset installation or commissioning and stored in the asset data foundation. In some embodiments, the system is configured to determine the geographic designation by comparing geographic coordinates of the asset against a coastal boundary definition stored in or accessible to the system, where the geographic coordinates and the coastal boundary definition are derived from GIS data described herein as a system input.

In some embodiments, the geographic designation is encoded as a feature for the AI model using one or more representations. In some embodiments, the geographic designation is encoded as a binary flag indicating coastal or non-coastal. In some embodiments, the geographic designation is encoded as a distance from coast expressed as a continuous variable, which provides the AI model with a more granular measure of environmental exposure than a binary flag. In some embodiments, the geographic designation is encoded as a categorical designation based on environmental exposure zones, where each zone represents a different level of salt air exposure severity.

In some embodiments, the system is configured to include the asset age and the geographic designation as features in the asset data and send the asset data to the AI model as part of a feature data set for training and/or prediction. In some embodiments, the asset age and the geographic designation are included in the asset data sent to the AI model for failure prediction. In some embodiments, the asset age and the geographic designation are included in the asset data paired with root cause designations to train the failure mode classification model described herein. In some embodiments, the asset age and the geographic designation are included in the asset data sent to the trained failure mode classification model for root cause prediction.

In some embodiments, the system is configured to collect and store failure data. In some embodiments, the system is configured to collect failure data from one or more outage and work management systems. In some embodiments, the system is configured to use the failure data to develop a failure label for a series or transformer data combinations. In some embodiments, the system is configured to combine the failure labels with at least a portion of the feature generation for those dates to develop a training data set for an AI model.

In some embodiments, the failure mode classification model is configured to classify asset failures into one or more root cause categories, rather than producing only a binary failure or non-failure designation. In some embodiments, root cause categories include, as non-limiting examples, windings failures, loose neutrals, overloading, energy theft or non-technical loss, ignition failures, heatwave failures, and/or any other failure mode of a utility asset.

In some embodiments, training the failure mode classification model includes constructing a training data set from historical failure data. In some embodiments, the system is configured to receive field inspection data comprising a root cause designation for a failed asset. In some embodiments, the root cause designation is categorized by a field inspector during a post-failure inspection of the failed asset. In some embodiments, the field inspection data is collected through one or more outage and work management systems. In some embodiments, the root cause designation includes one or more of windings failure, loose neutral, overloading, energy theft or non-technical loss, ignition failure, heatwave failure, and/or any other failure mode identified during the field inspection.

In some embodiments, the system is configured to receive a duration of observable anomaly associated with the failed asset. In some embodiments, the duration of observable anomaly defines a time window of anomalous behavior in the meter data and/or feature data that preceded the failure.

In some embodiments, the system is configured to calculate the duration of observable anomaly by performing a retrospective analysis of stored historical meter data for the failed asset. In some embodiments, the retrospective analysis includes analyzing the historical meter data backward from the confirmed failure date to identify the earliest point at which the meter data deviated from normal operating conditions. In some embodiments, the deviation from normal operating conditions is determined by the system using one or more of statistical thresholds applied to voltage data, comparison of the failed asset's voltage to bellwether voltages from upstream and/or downstream transformers, and/or any other anomaly detection methods described herein. In some embodiments, the system is configured to compute the duration of observable anomaly as the elapsed time between the identified earliest deviation and the confirmed failure date.

In some embodiments, the duration of observable anomaly is designated by a field inspector during a post-failure inspection, where the field inspector designates the duration based on physical evidence observed during the inspection that indicates the approximate onset of the failure condition. In some embodiments, both the system-calculated duration and the inspector-designated duration are captured and stored by the system. In some embodiments, the system is configured to compare the system-calculated duration and the inspector-designated duration to identify discrepancies, where identified discrepancies are used to refine the anomaly detection thresholds used in the retrospective analysis and to improve the accuracy of future duration estimates.

In some embodiments, the system is configured to retrieve the asset data corresponding to the duration of observable anomaly window for the failed asset. In some embodiments, the duration of the observable anomaly window defines the specific time period from which the system retrieves historical feature data for the failed asset. In some embodiments, the asset data corresponding to the duration of observable anomaly window comprises the meter data, voltage features, bellwether voltage features, loading data, aggregated loading percentage, insulation degradation assessment, temperature data, number of consecutive days exceeding a specified threshold, estimated air conditioning demand, asset age, geographic designation, and/or any other features generated by the system for the failed asset during the time period defined by the duration of observable anomaly.

In some embodiments, the system is configured to pair the retrieved asset data from the duration of observable anomaly window with the root cause designation to create a labeled training example, where the asset data from the anomaly window serves as the model input and the root cause designation serves as the corresponding label that the model learns to predict. In some embodiments, the system is configured to repeat this process across a plurality of historical failures to build a training data set comprising labeled training examples spanning multiple root cause categories, such that the training data set includes examples of the anomaly patterns associated with each root cause category.

In some embodiments, the duration of observable anomaly is included as a feature in the labeled training example. In some embodiments, different failure modes exhibit different characteristic anomaly durations prior to failure. In some embodiments, the duration of observable anomaly is included as a feature in the labeled training example, enabling the failure mode classification model to learn the characteristic anomaly duration associated with each root cause category and to use the anomaly duration as a distinguishing signal when classifying new assets. In some embodiments, the duration of the observable anomaly serves a one or more roles: as a label attribute that the system uses to determine which portion of the historical asset data to retrieve for the labeled training example, and/or as a feature value within that labeled training example that the failure mode classification model uses for prediction.

In some embodiments, the system is configured to train the failure mode classification model using the training data set. In some embodiments, the failure mode classification model is configured to learn the relationship between the anomaly patterns observed in the feature data during the anomaly window and the root cause category that ultimately resulted in failure. In some embodiments, the failure mode classification model is configured to classify asset data into one or more root cause categories based on patterns learned from the training data set. In some embodiments, the failure mode classification model is trained using the same cross-validation and training-test split methodology described herein for the failure prediction model, where cross-validation groups are maintained by substation and feeder to ensure that the model generalizes across different portions of the electrical distribution system.

In some embodiments, the failure mode classification model operates as a downstream stage that receives the output of the failure prediction model described herein, where the failure prediction model first determines a probability of failure for one or more assets, and the system then provides the asset data for those assets identified as having an elevated probability of failure to the failure mode classification model for root cause classification. In some embodiments, the failure mode classification model is used to classify a confirmed failure, where the system provides the asset data from the period preceding the confirmed failure to the failure mode classification model, and the failure mode classification model outputs a predicted root cause classification based on the pre-failure asset data without requiring the failure prediction model to have previously identified the asset as having an elevated probability of failure. In some embodiments, the system is configured to operate the failure mode classification model in both configurations, classifying the predicted root cause for assets flagged by the failure prediction model as at risk of failure, and classifying the predicted root cause for assets that have already failed, such that the system provides root cause assessments both before and after failure occurs.

In some embodiments, the system is configured to provide asset data for a target asset to the failure mode classification model. In some embodiments, the asset data for the target asset comprises the meter data, voltage features, bellwether voltage features, loading data, aggregated loading percentage, insulation degradation assessment, temperature data, number of consecutive days exceeding a specified threshold, estimated air conditioning demand, asset age, geographic designation, and/or any other features generated by the system for the target asset. In some embodiments, where the target asset is exhibiting anomalous behavior, the asset data includes the elapsed time since a first detected anomaly for the target asset, which corresponds to the duration of observable anomaly feature used during model training.

In some embodiments, the system is configured to output, by the failure mode classification model, a predicted root cause classification for the target asset. In some embodiments, the predicted root cause classification comprises a single root cause label representing the most probable failure mode for the target asset. In some embodiments, the predicted root cause classification comprises a ranked list of probable root causes ordered by probability. In some embodiments, the predicted root cause classification comprises a probability distribution across all root cause categories, where each root cause category is assigned a probability value indicating the likelihood that the target asset will fail due to that root cause. In some embodiments, the predicted root cause classification comprises any combination of a single root cause label, a ranked list of probable root causes, and a probability distribution across root cause categories.

In some embodiments, the system is configured to generate a graphical user interface displaying the predicted root cause classification for the target asset. In some embodiments, the graphical user interface displays the predicted root cause classification alongside the match or non-match designation described herein, such that a user can view both the failure probability and the predicted failure mode for the target asset in a single interface. In some embodiments, the graphical user interface comprises an input configured to enable a user to change the predicted root cause classification. In some embodiments, the system is configured to receive a user correction to the predicted root cause classification via the graphical user interface. In some embodiments, the user correction comprises a change from the predicted root cause classification to a different root cause category designated by the user based on the user's domain expertise or additional information not available to the model. In some embodiments, the system is configured to send the user correction to the failure mode classification model to improve classification accuracy. In some embodiments, the user correction is incorporated into the training data set as an additional labeled training example and used to retrain or update the failure mode classification model, following the same feedback mechanism described herein for the match or non-match designation.

In some embodiments, the system is configured to generate a prioritization ranking for one or more assets based at least in part on the predicted root cause classification. In some embodiments, the system is configured to assign a priority score to each of the one or more assets based on the predicted root cause classification. In some embodiments, root cause categories associated with ignition or wildfire risk are assigned a higher priority than root cause categories associated with service interruption only, reflecting the greater severity of potential consequences. In some embodiments, root cause categories associated with safety risk to persons or property are assigned a higher priority than root cause categories associated with equipment degradation without immediate safety risk. In some embodiments, the system is configured to combine the priority score derived from the predicted root cause classification with the probability of failure from the failure prediction model to generate a composite priority score, such that an asset with both a high probability of failure and a high-severity root cause classification receives a higher composite priority score than an asset with either factor alone. In some embodiments, the prioritization ranking is used by the system to automatically, without human intervention, generate one or more actions including scheduling maintenance, rerouting electricity, ordering replacement parts and/or assets, generating reports, and/or initiating replacement of assets, where assets with higher priority scores are addressed before assets with lower priority scores. In some embodiments, the prioritization ranking is displayed on the graphical user interface to enable a user to review and act on the prioritized list of assets including overriding any automated functionality if desired.

In some embodiments, the predicted root cause classification is used to support reporting. In some embodiments, the system is configured to generate one or more reports comprising the predicted root cause classification for one or more assets, the prioritization ranking, and/or summary statistics of predicted root cause categories across a population of assets, enabling utility operators to identify systemic patterns such as a concentration of a particular failure mode in a geographic area or on a particular feeder. In some embodiments, the predicted root cause classification is used to support model improvement. In some embodiments, the system is configured to compare predicted root cause classifications against subsequently confirmed root causes from field inspections to measure classification accuracy and identify root cause categories where the model requires additional training data or retraining.

In some embodiments, the system is configured to use some or all of the data collected as described herein to create a feature data set which is used to train artificial intelligence (AI) including machine learning. Embodiments described herein that are directed to a machine learning model are merely an example of implementation of the system using a subset of AI to aid those of ordinary skill in making and using the system. A reference to any subset of AI is not limiting and does not exclude the use of other types of AI to implement various aspects of the system. A general refence to a/the system “model” includes one or more subsets of AI. Depending on specific system configurations according to some embodiments, additional features described herein may be included, or specified features may be excluded to train a model.

In some embodiments, training and/or calibrating the model includes one or more stages. In some embodiments, training and/or calibrating the model includes a two-stage process. In some embodiments, a first stage includes developing a balanced training set which includes data sampled prior to component failures and randomly sampled non-failure data to create a pre-fit trained model. In some embodiments, the pre-fit trained model is then used to train a calibrated model against a time series of regularly spaced times with sampled failed and non-failed assets.

In some embodiments, the model includes balanced and/or imbalanced training data. In some embodiments, incipient behavior may or not be present n-days prior to a failure. In some embodiments, failures with incipient behavior are relatively rare ( less than 0.5%). In some embodiments, a balanced data set has been generated from known failures, and a sample of normal behavior. In some embodiments, to calibrate the model, a more representative distribution is desired, so a data set using a different sampling approach is generated. In some embodiments, cross validation and training test splits are disjoint across both datasets.

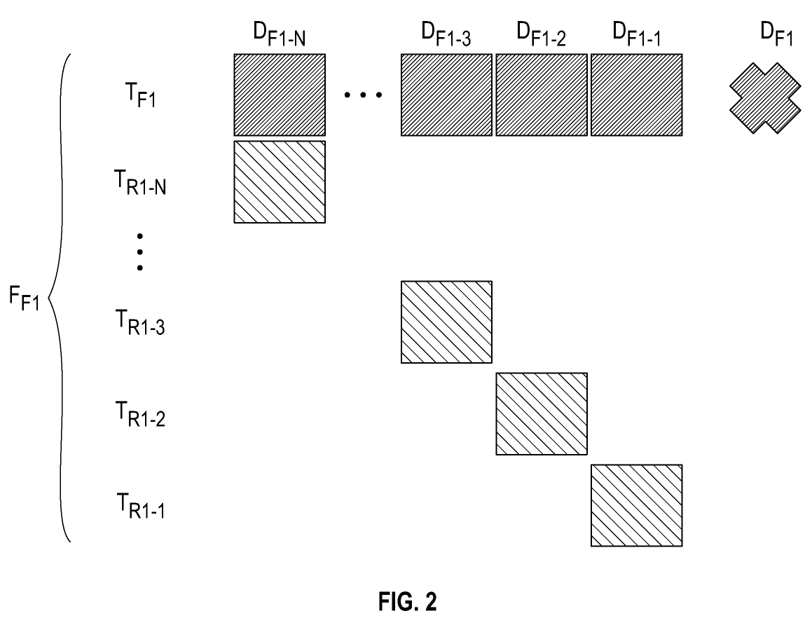

FIG. 2 illustrates a non-limiting example of training data according to some embodiments. In some embodiments, for each failure date (D_{F}) in a given a set of failed transformer (T_{F}) dates, the system is configured to generate a list of predecessor dates D_{F1-N} through _{DF1-1} where incipient failure behavior was present. Initially, this is assumed to be a constant N days according to some embodiments. In some embodiments, for each day, the system is configured to select a random transformer (T_{R}) on the same feeder F in order to provide a baseline transformer performance for comparison.

In some embodiments, for the purposes of cross validation, the system is configured to generate a cross validation (CV) group attribute which maintains individual substations and feeders in separate cross validation groups. In some embodiments, dates are not initially separated. In some embodiments, when 2 or more years of data is available to the system, model training and testing includes different years of data. In some embodiments, this generates a list of balanced samples and maximizes use of failure data.

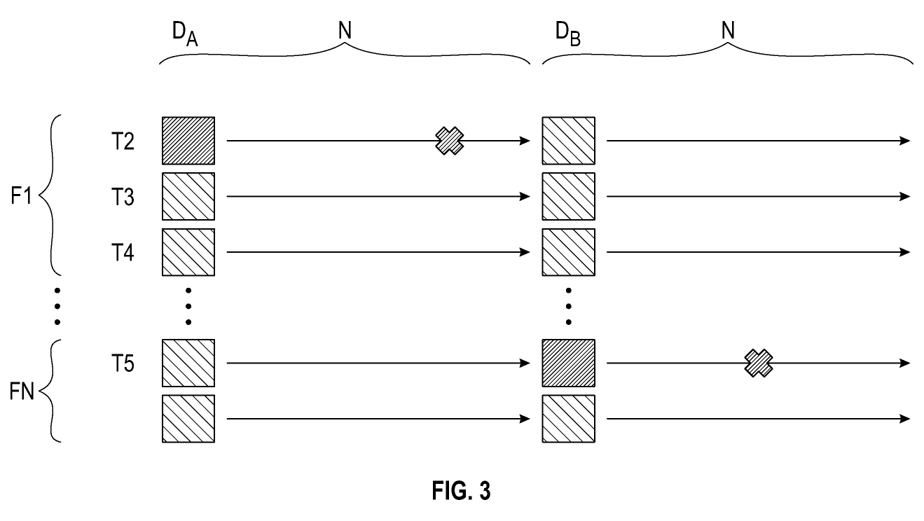

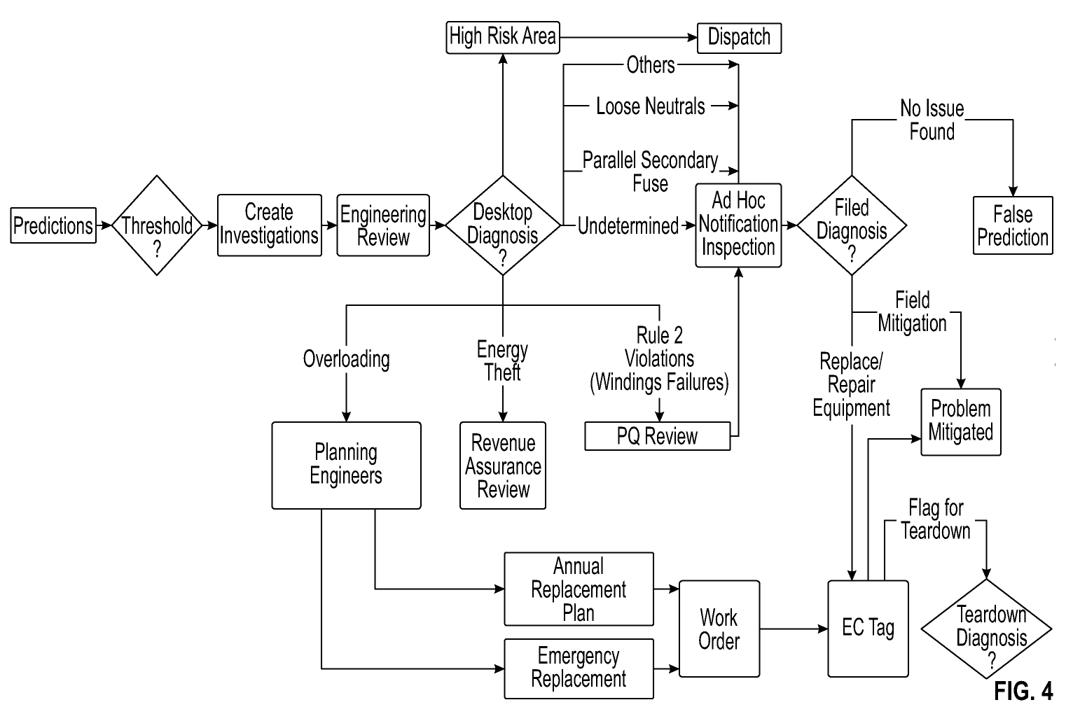

FIG. 3 depicts calibration data according to some embodiments. In some embodiments, the system includes calibration data that includes a sampled sequence over a specified time period. In some embodiments, the calibration data includes a sample of time (e.g., a sequence of days) over a timespan (e.g., year) of data. In some embodiments, for each day (D), the system looks at all or a random subsample of transformers (T), and labels the transformers which fail within N days of the sampled day as a calibration data set (D_{A} , D_{B} … D_{N}). In some embodiments, the system includes calibrating the trained model using the calibration data set. In some embodiments, the system includes incorporating any cross-validation groupings from the original model by using feeder attributes. In some embodiments, the system includes testing against separate feeders (electrical transmission lines), and once available, a separate year of data. FIG. 4 shows a flowchart for a method of implementing corrective action for various types of identified anomalies according to some embodiments.

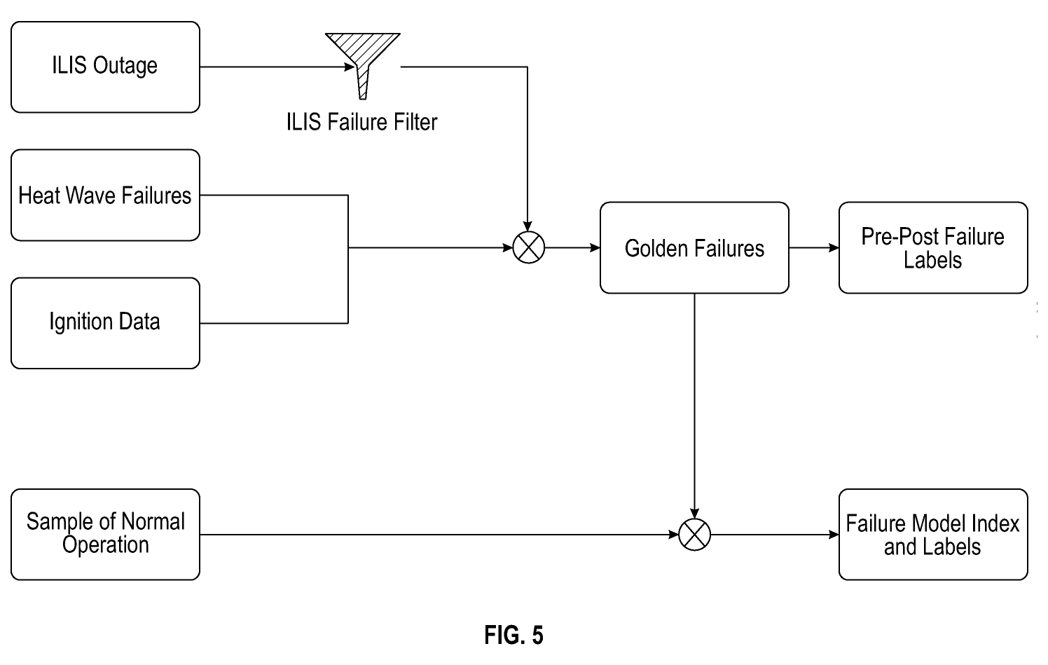

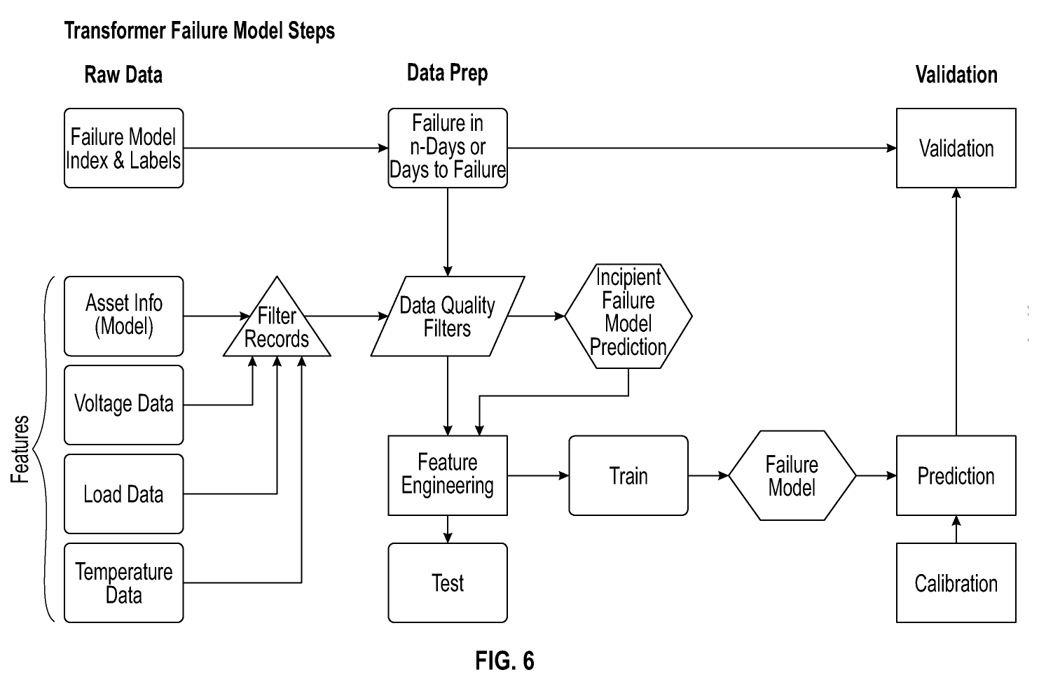

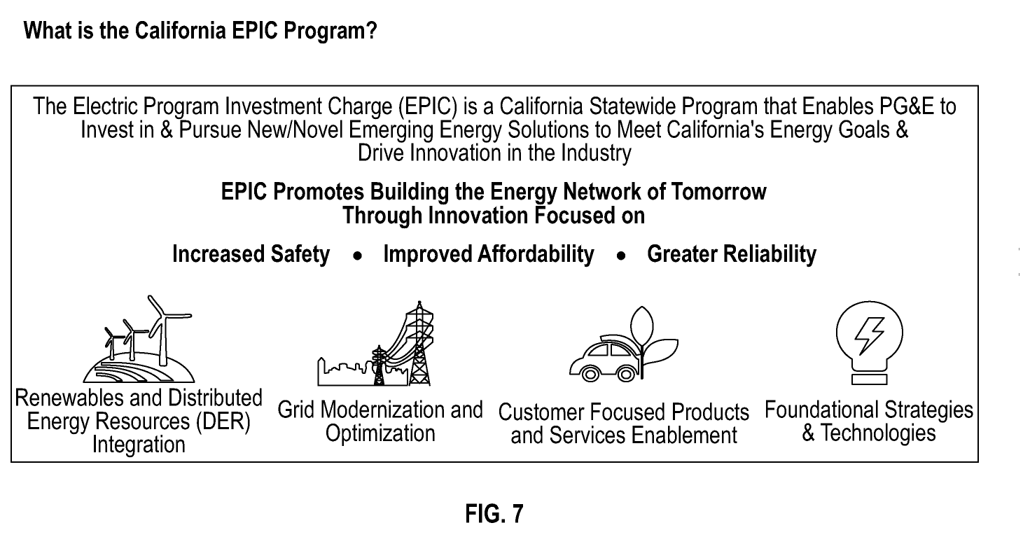

FIG. 5 shows a modeling process flow according to some embodiments. In some embodiments, failures input into the system include Integrated Logging and Information system (ILIS) outages, heat wave failures, and/or ignition failures, as non-limiting examples. In some embodiments, the ILIS is configured to model the actual electrical switching operations reported during a circuit restoration process. In some embodiments, the ILIS failure filter is configured to remove transformer anomalies that are related to intentional electrical distribution changes such as rerouting. In some embodiments, golden failure comprising distinct data failure indicators are stored and/or sent along with a sample of normal operating transformers for failure model indexing and labeling through a graphical user interface (GUI). In some embodiments, golden failure comprising distinct data failure indicators are sent to a pre-post failure module where a data failure indicators of pre-failure anomalies and/or post failure anomalies are labeled for AI training. In some embodiments, both the pre-post failure labels and the failure model index and labels are then used to train the AI model. FIG. 6 illustrates a non-limiting example of transformer failure model method steps according to some embodiments. FIG. 7 depicts a program for evaluating implementations of the system according to some embodiments.

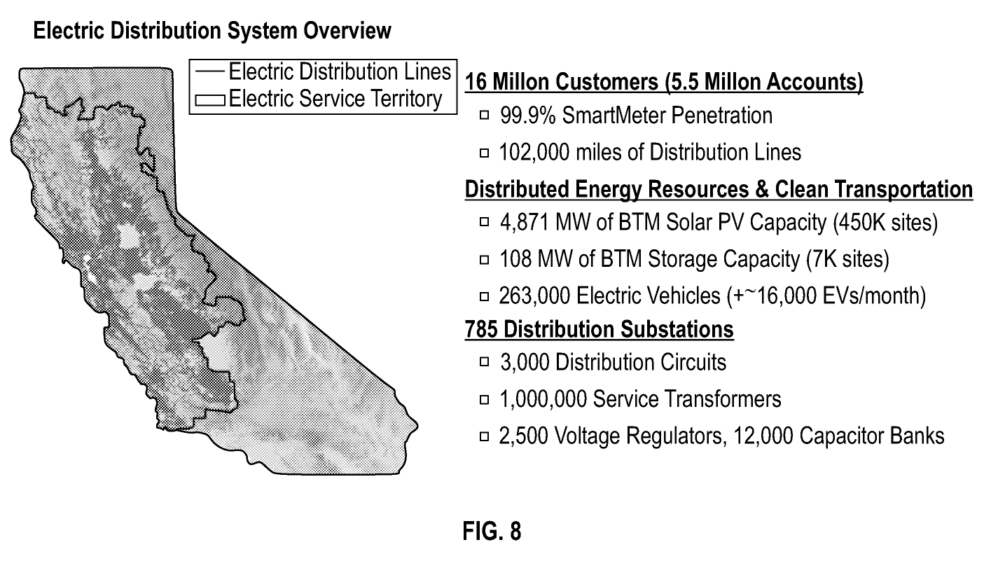

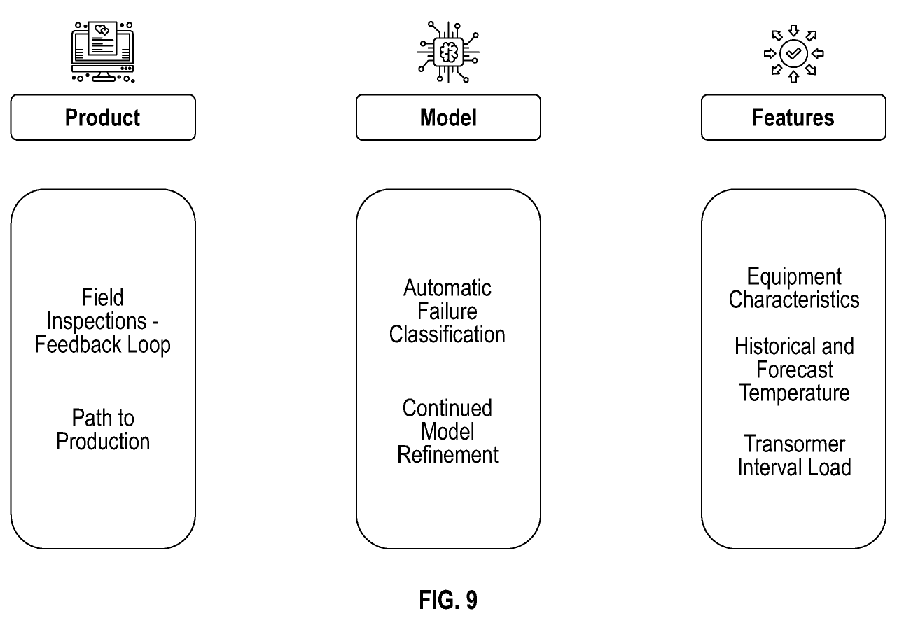

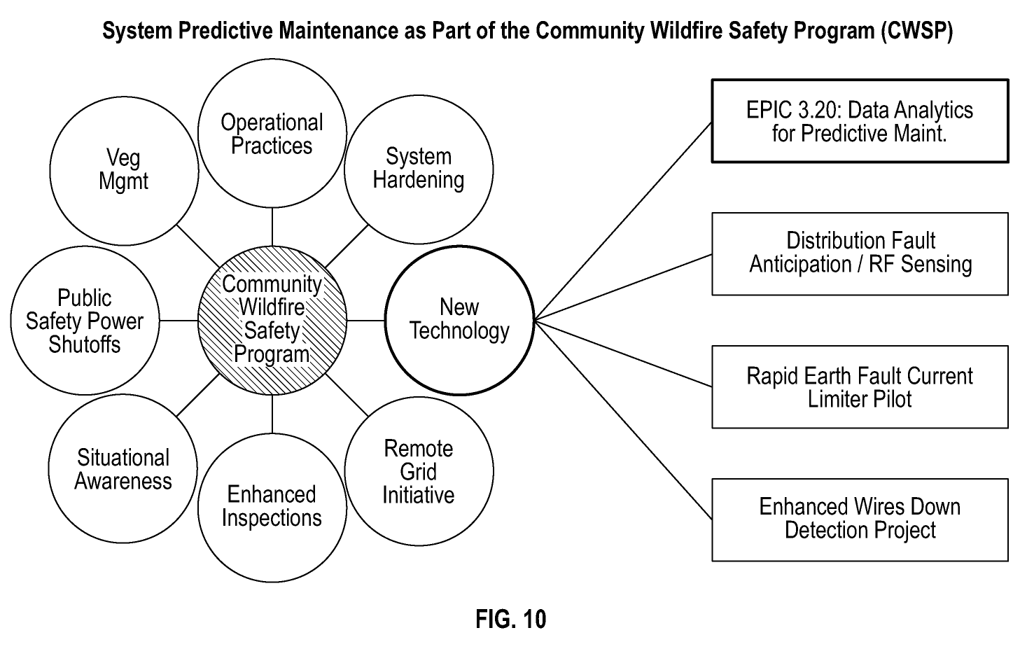

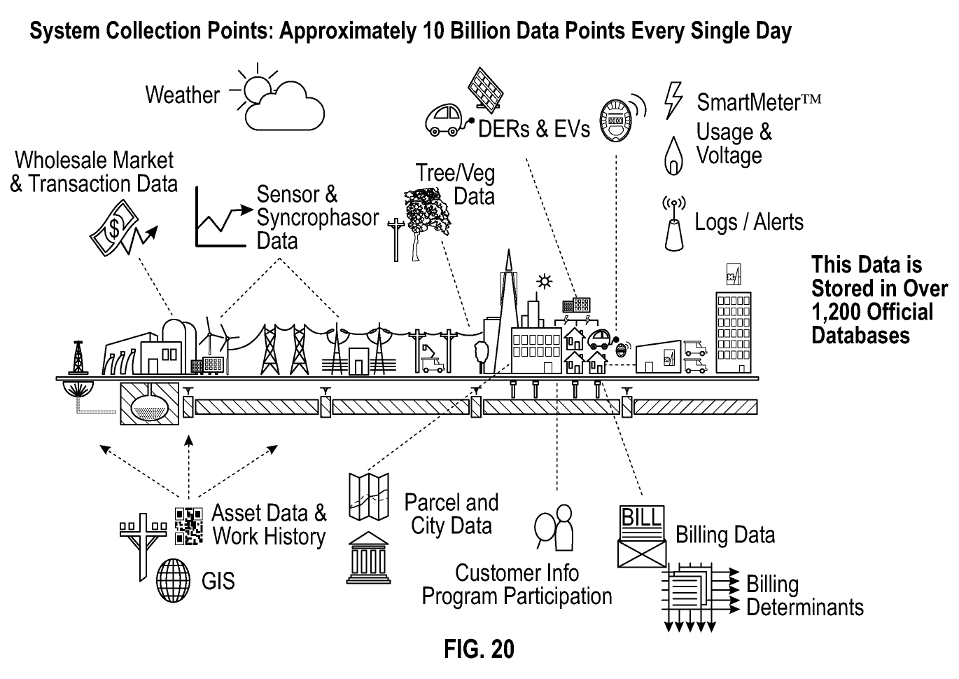

FIGS. 7-28 illustrate a non-limiting system implementation overview including various system configurations and implemented steps according to some embodiments. In some embodiments, the system can be used in conjunction with the Electrical Program Investment Charge (EPIC) program to help achieve California’s energy goals. FIG. 7 includes an overview of the California Epic program according to some embodiments. FIG. 8 shows an electrical distribution system suitable for implementation of the system according to some embodiments. FIG. 9 shows steps for system implementation and refinement by a utility according to some embodiments. FIG. 10 shows the system implemented as part of the Community Wildfire Safety Program (CWSP) according to some embodiments.

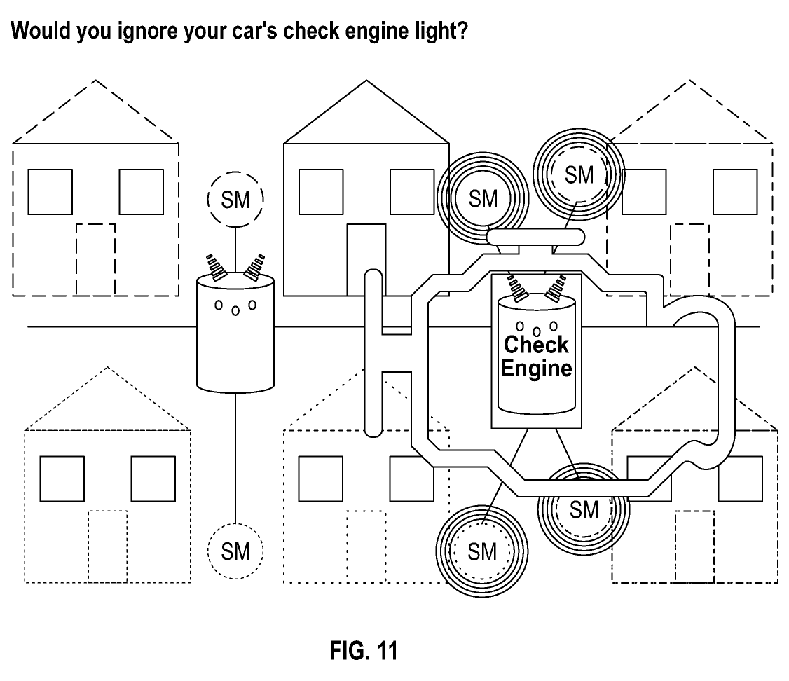

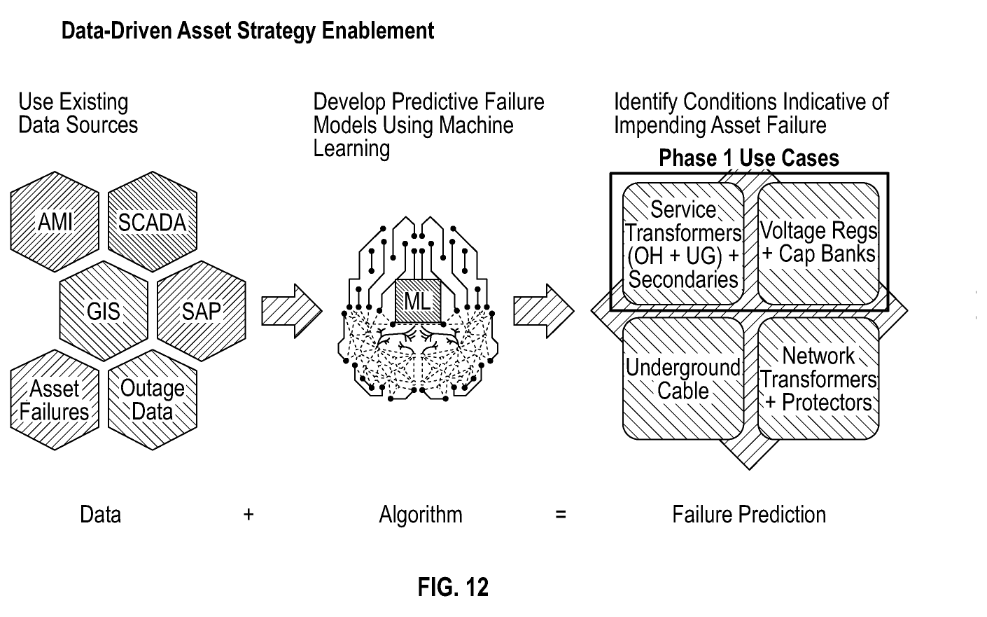

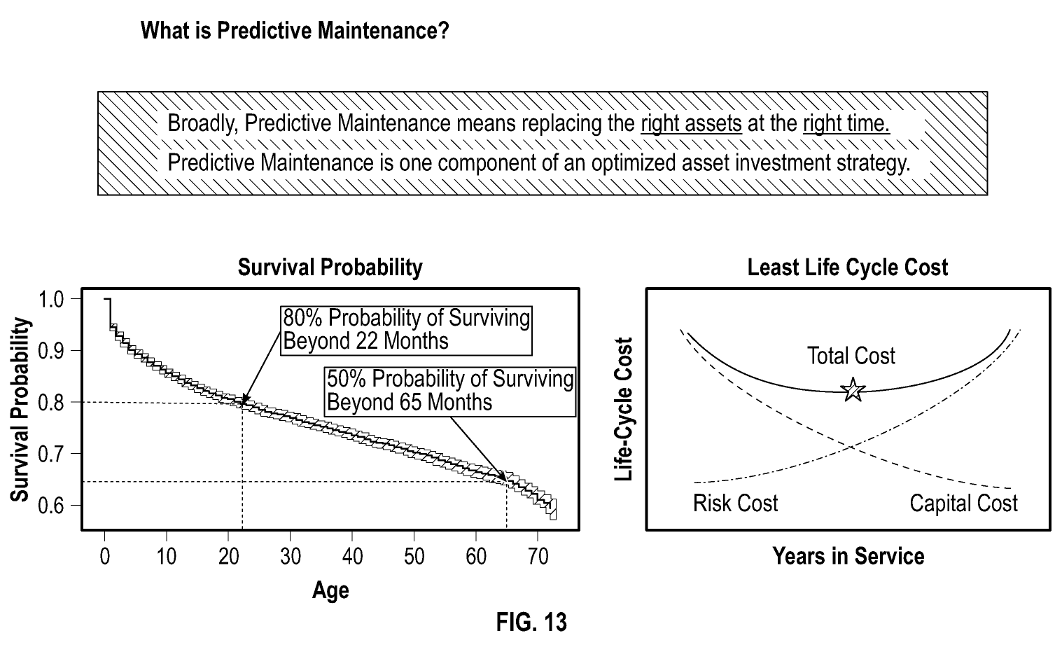

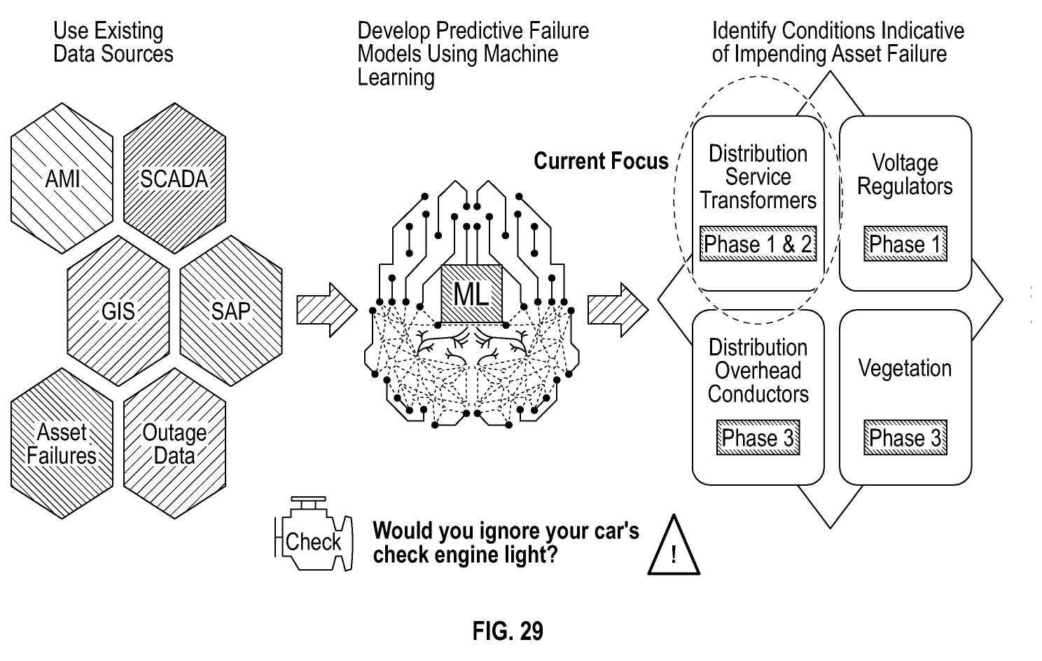

FIG. 11 illustrates the analogy of using aspects of the system as a “check engine light” according to some embodiments. FIG. 12 shows the system’s data-drive asset strategy enablement according to some embodiments, which are discussed further with regard to FIG. 29. FIG. 13 illustrates a predictive maintenance strategy according to some embodiments. In some embodiments, the system is configured to generate survival probability charts based on historical failure. In some embodiments, the system is configured to generate failure reports and/or notification when an asset probability of survival falls below a pre-determined value (e.g., 50%).

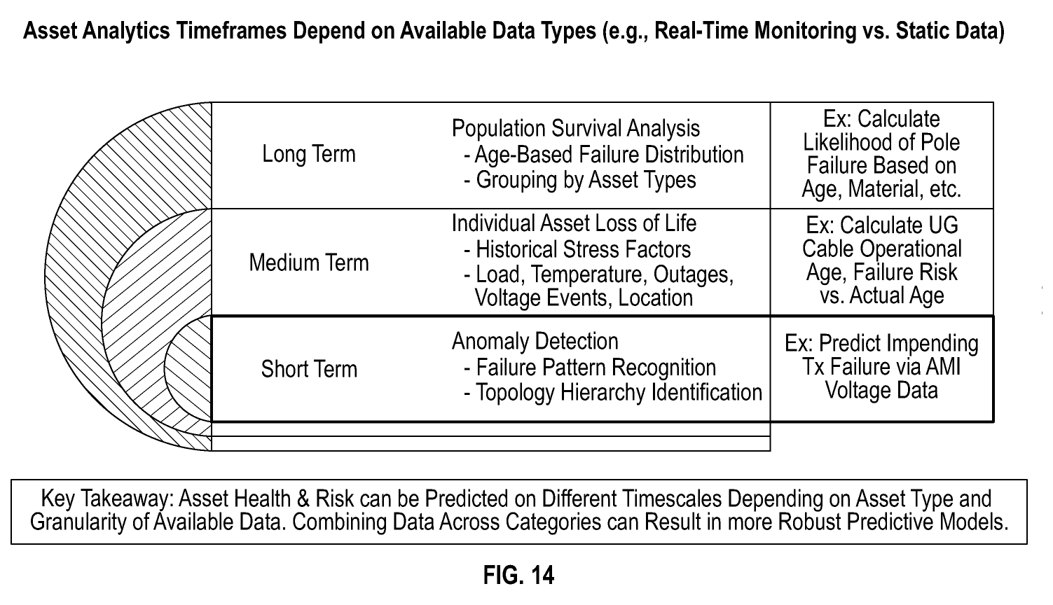

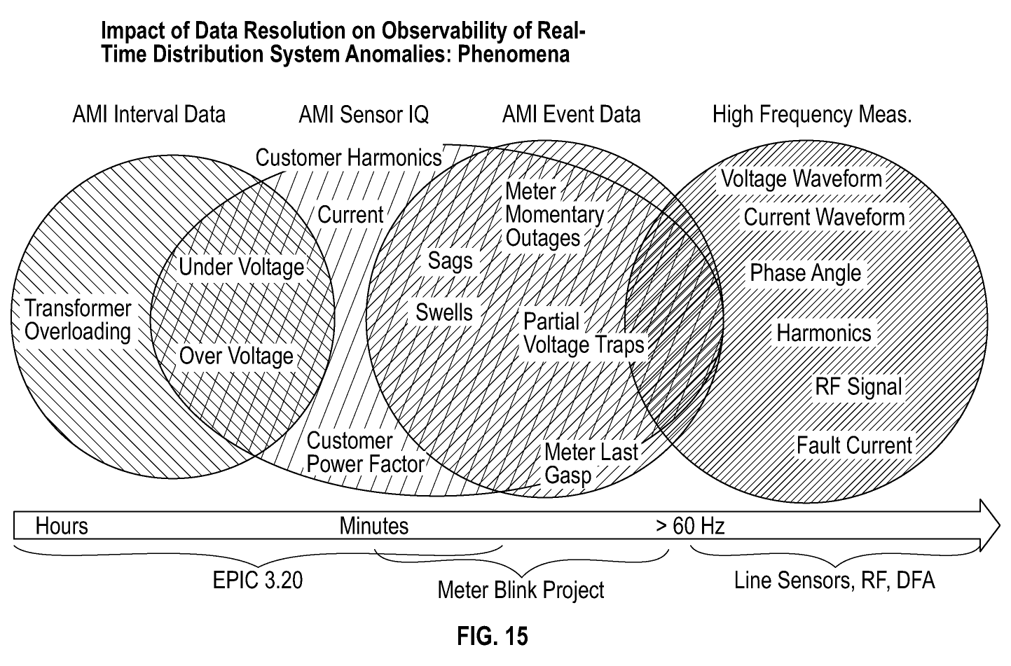

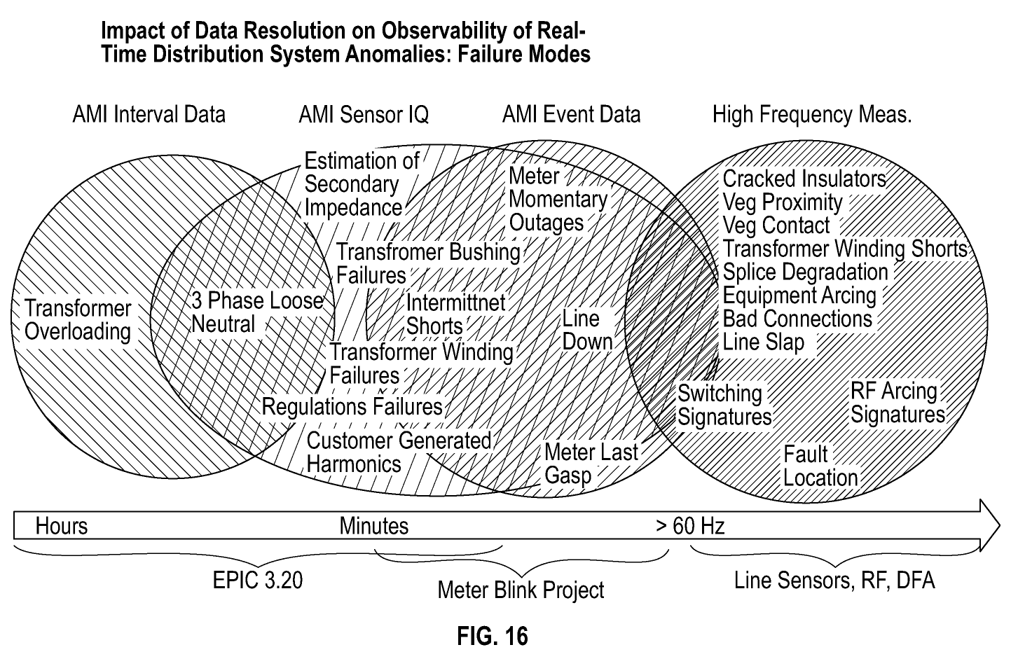

FIG. 14 shows asset (component) analytics timeframes dependent on available data types according to some embodiments. In some embodiments, the system is configured to group assets (e.g., transformers) by term for analysis. In some embodiments, the system is configured to group monitoring of assets with long term life (e.g., 70% - 99% expected useful life) for analysis based on historical data. In some embodiments, the system is configured to group monitoring of assets with medium term life (e.g., 30% - 69% expected useful life) for analysis based on operational data. In some embodiments, the system is configured to group monitoring of assets with medium term life (e.g., 1% - 29% expected useful life) for analysis based on AI data. FIG. 15 shows the phenomena of data resolution impact on observability of near real-time distribution system anomalies according to some embodiments. FIG. 16 shows the failure modes of data resolution impact on observability of near real-time distribution system anomalies according to some embodiments.

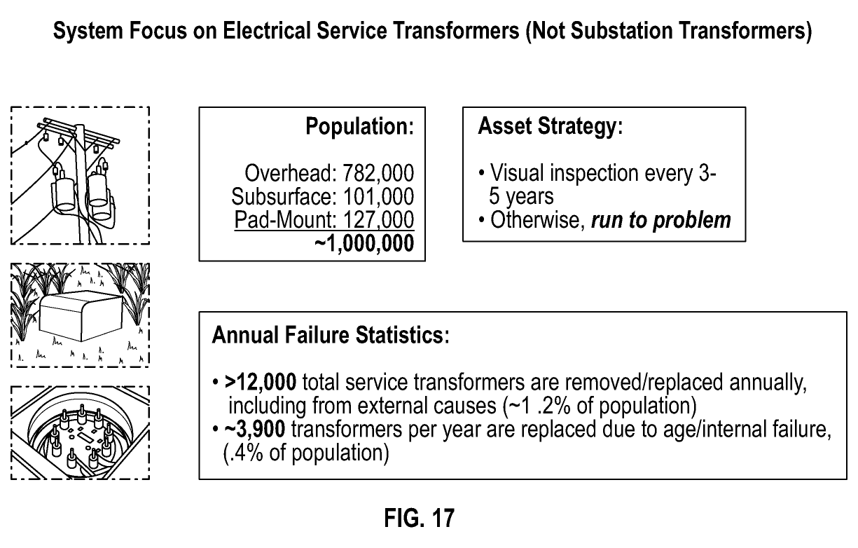

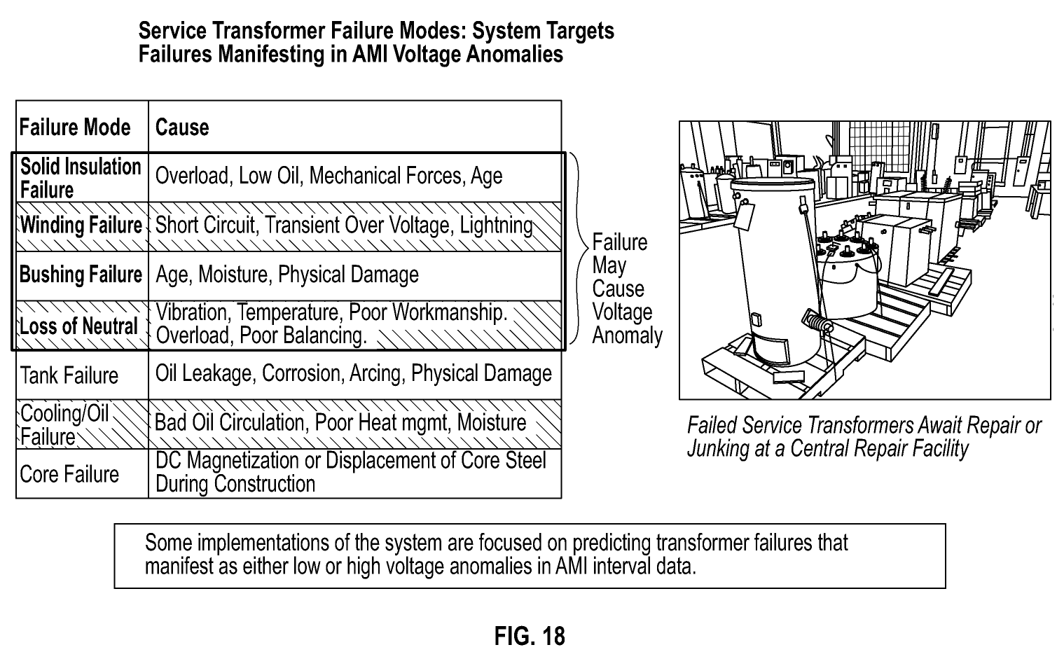

FIG. 17 shows the system’s focus on electrical service transformers and not substation transformers according to some embodiments. In some embodiments, the system is configured to identify anomalies in service transformers, which include a transform that provides the transformation of the final voltage step in the AMI. Conventional practices do not include remote monitoring and/or analysis of service transformers according to some embodiments. In some embodiments, service transformers are only visually inspected every few years, or are allowed to run to failure due to no conventional monitoring techniques. FIG. 18 illustrates how the system targets failures manifesting in advanced metering infrastructure (AMI) voltage anomalies according to some embodiments. In some embodiments, the system is configured to predict asset failure types. In some embodiments, the system is configured to predict asset failure by identifying anomalies in AMI interval data. In some embodiments. In some embodiments, the system is configured to predict asset failure by identifying one or more of high and low voltage anomalies in AMI interval data.

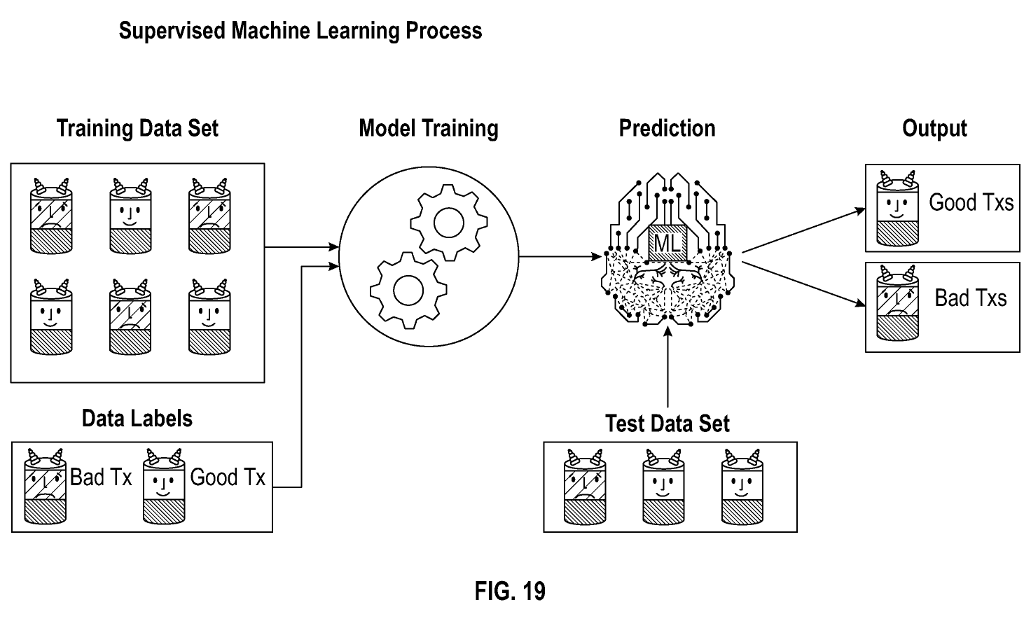

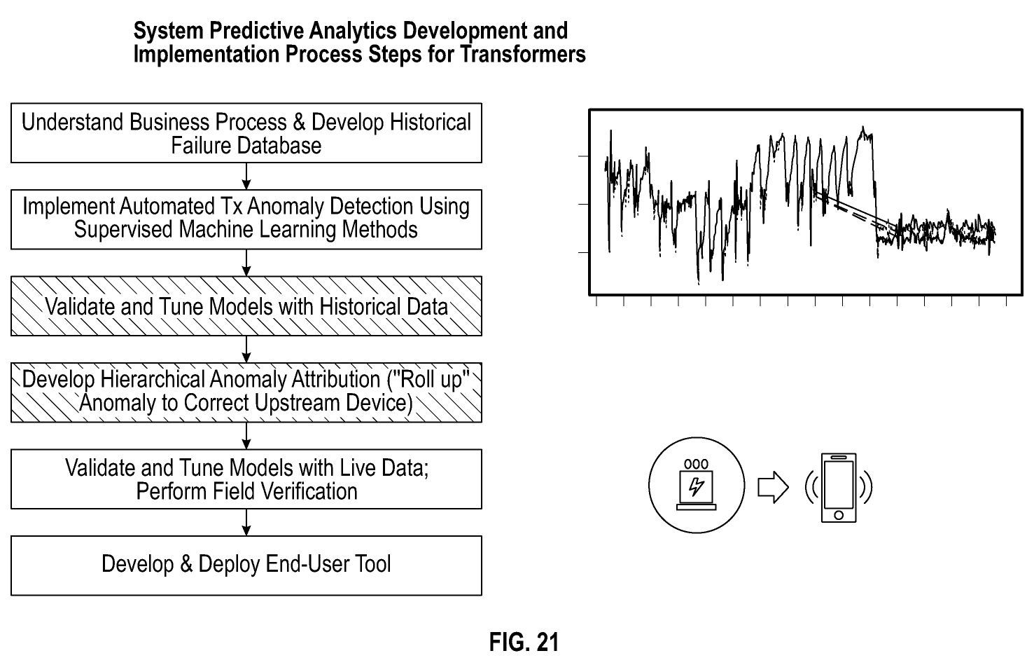

FIG. 19 illustrates steps for implementing a supervised system machine learning process according to some embodiments. In some embodiments, an artificial intelligence model (AI); e.g., machine learning model) is trained with a training data set, where each data example is labeled as an example of an indication of a good or bad transformer (Tx). In some embodiments, the model training is then used by the model for prediction. In some embodiments, the system is configured to receive one or more remote monitoring parameters and output a transformer failure prediction based on the one or more remote monitoring parameters. In some embodiments, the system is configured to display the transformer failure prediction on a graphical user interface (GUI). In some embodiments, the system is configured to enable a user to change an output designation. In some embodiments, changing an output designation includes changing a “good” transformer output to a “bad” transformer output, and vice versa. In some embodiments, the term “good” as used herein means that a transformer is predicted to have between 50% to 99% of useful life remaining before failure. In some embodiments, the term “bad” as used herein means that a transformer is predicted to have between 1% and 49% of useful life remaining before failure. In some embodiments, “useful life” includes the average time and/or hours of use an asset is expected to provide before failure. In some embodiments, the system is configured to calculate useful life based on historical asset lifespan data. FIG. 21 shows system predictive analytics development and implementation process steps for transformers according to some embodiments.

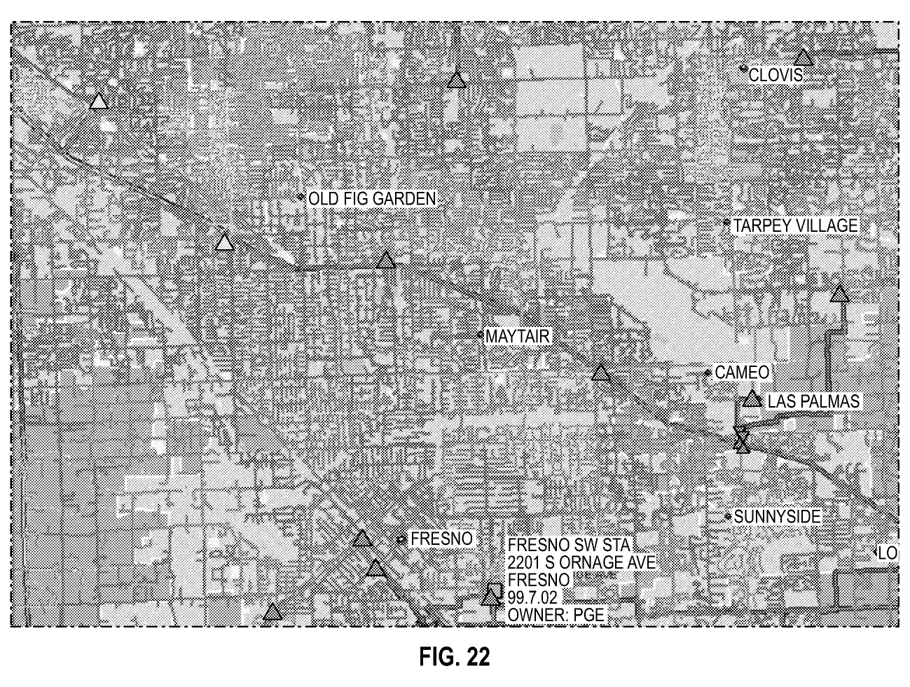

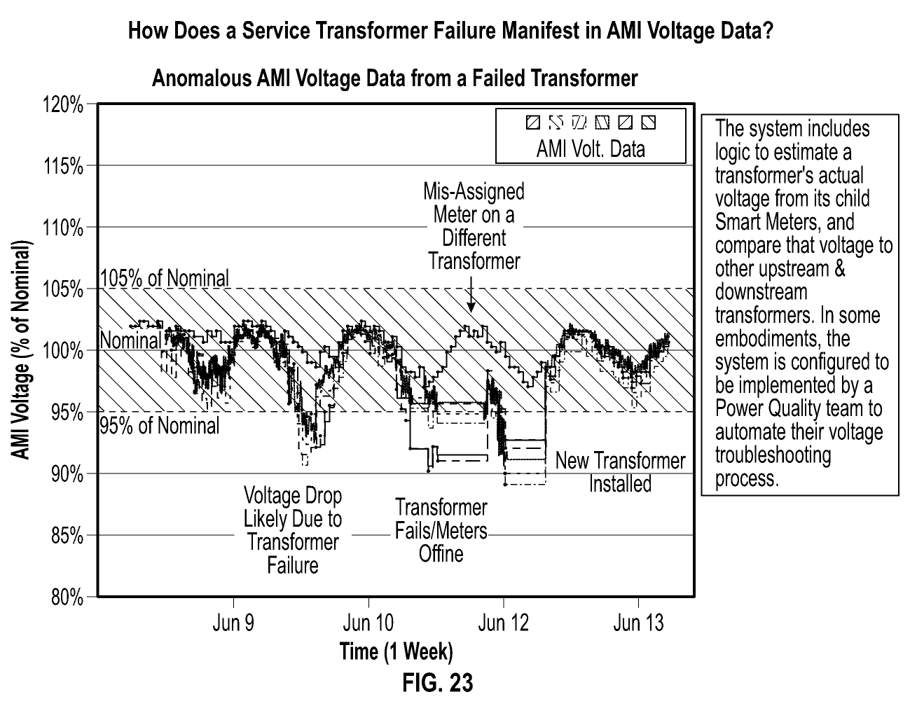

FIG. 22 depicts a map of utility asset voltage distribution according to some embodiments. As evident by FIG. 22, manual inspection of all assets in an AMI would be too costly, and even if it were feasible, visual inspection would not yield the same type of data as provided by the system according to some embodiments. FIG. 23 shows how service transformer failure manifest in AMI voltage data according to some embodiments. In some embodiments, the system is configured to analyze voltage data to determine transform failure. In some embodiments, the AI model is configured to analyze and/or predict transformer health for one or more voltage signals as they are received by the system. In some embodiments, the system is configured to provide a summary data set to the AI model comprising a statistical representation of the one or more voltage signals that comprises fewer than all voltage signals in order to save computer resources.

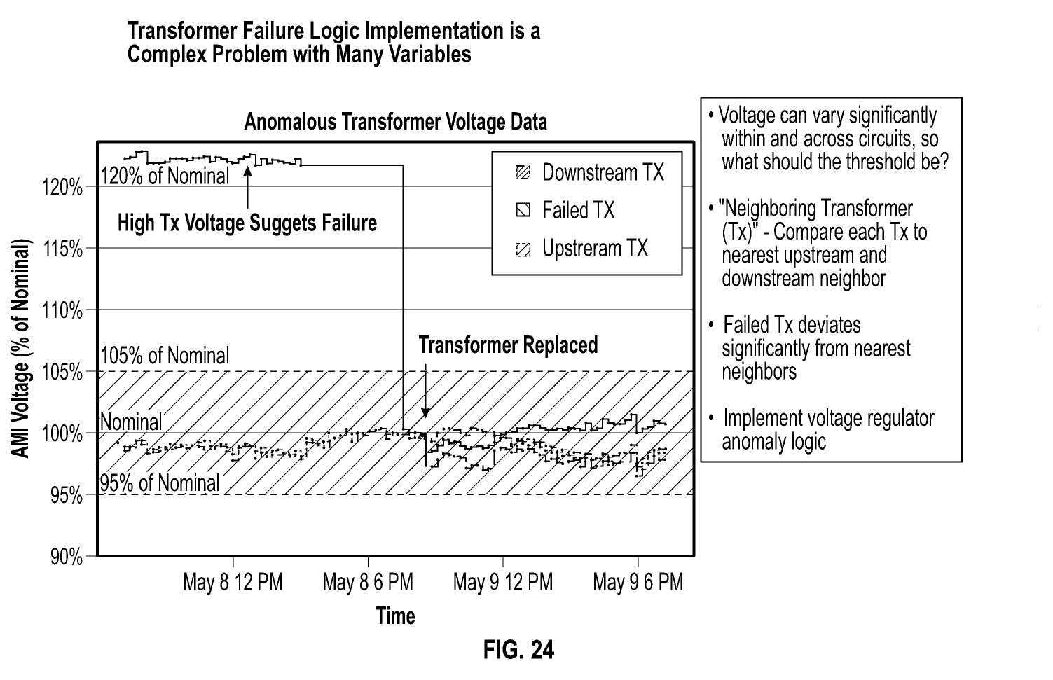

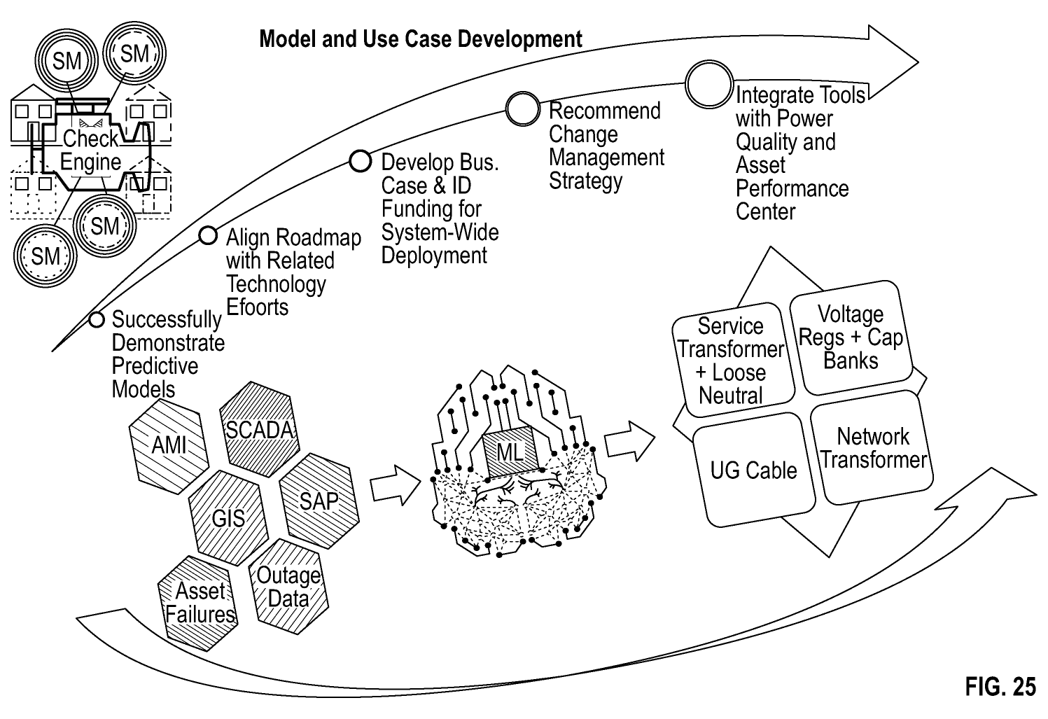

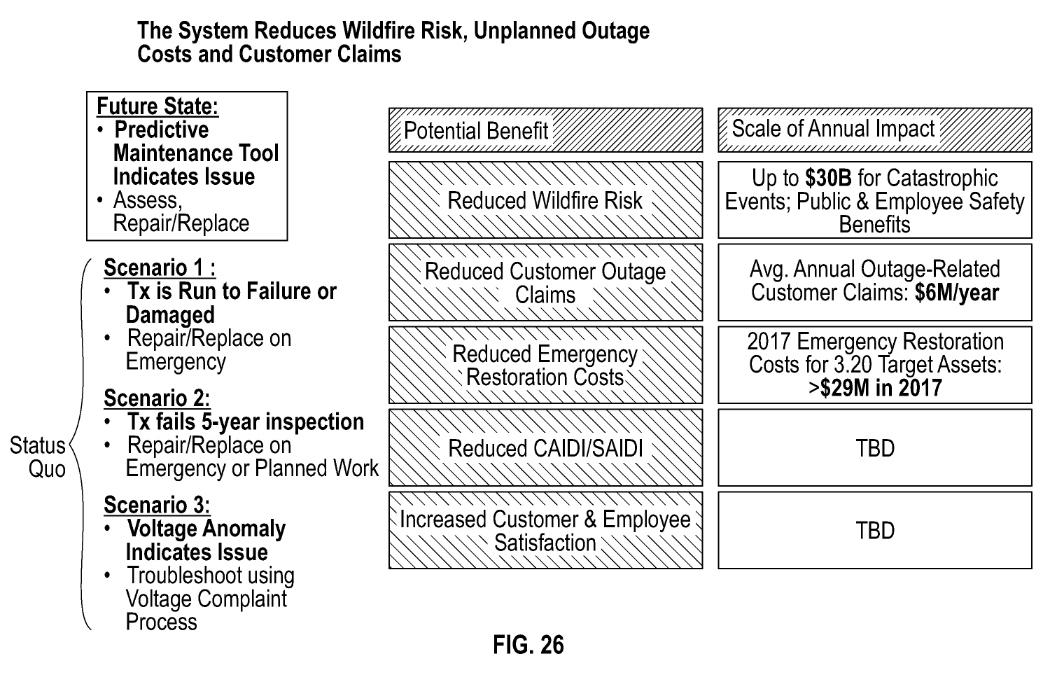

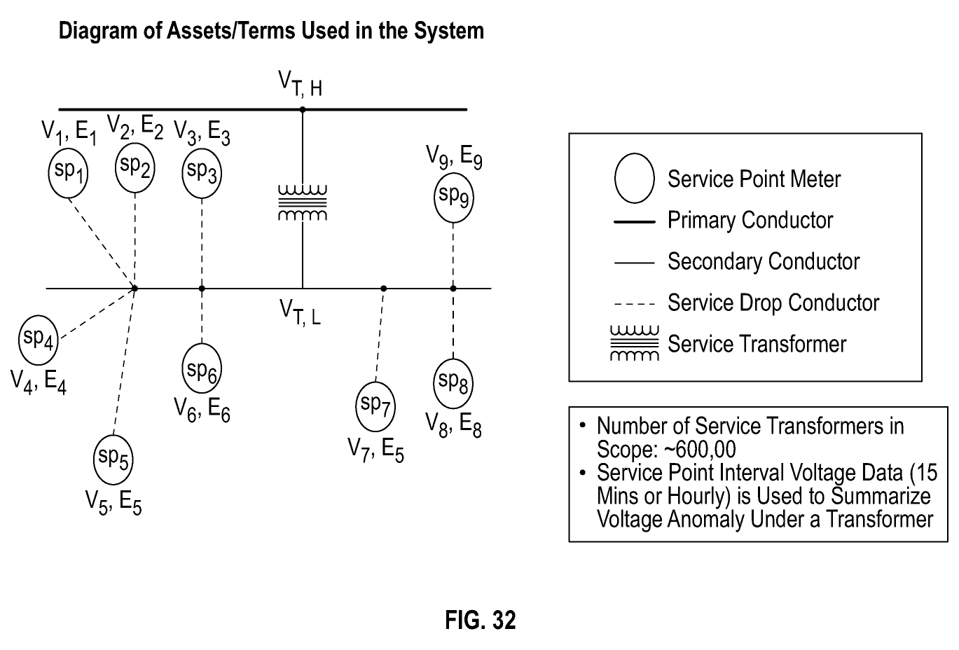

FIG. 24 illustrates how transform failure logic implementation is a complex problem with many variables in some embodiments. In some embodiments, to overcome this challenge, the system is configured to compare each transformer signal to one or more upstream (toward the electrical supply) transformer signals and/or one or more downstream (away from the electrical supply) transformer signals. In some embodiments, one or more transformer signals include one or more signals from one or more transformer sensors. In some embodiments, one or more transfer sensors include voltage sensors, current sensors, power factor sensors, camera images, and the like, electrically or otherwise suitable coupled to a transformer. In some embodiments, one or more transformer signals include one or more signals from one or more (smart) meters located on a secondary conductor (see FIG. 32). In some embodiments, one or more downstream transformer signals comprise a signal from a nearest downstream transformer. FIG. 25 shows a model and use case development according to some embodiments. FIG. 26 shows how the system provides the benefit of reducing wildfire risk, unplanned outage cost, and customer claims according to some embodiments.

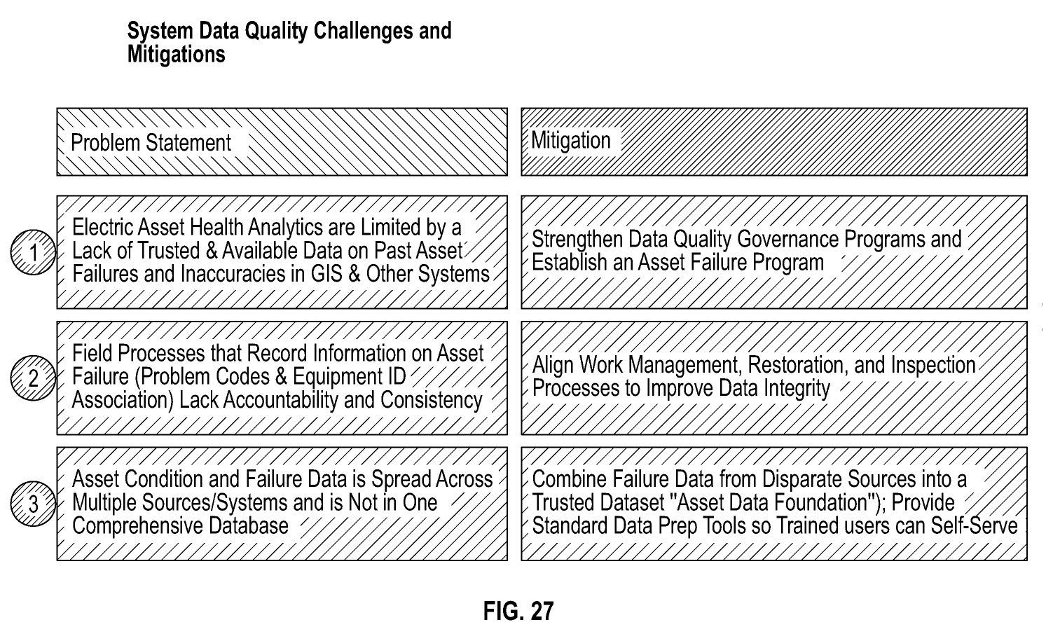

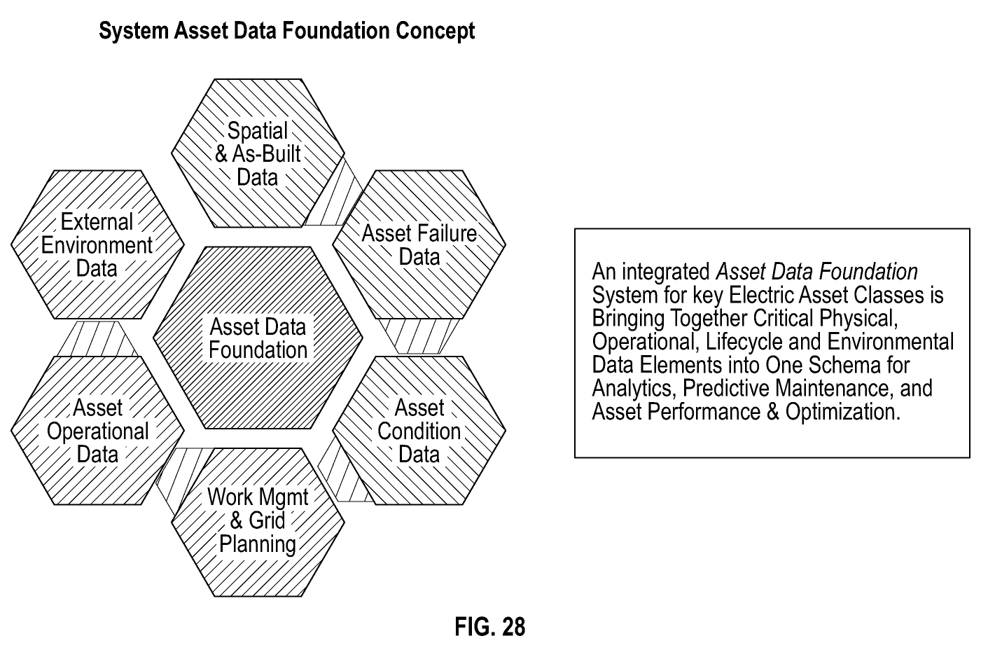

FIG. 27 depicts system data quality challenges and mitigations according to some embodiments. In some embodiments, the system includes a system asset data foundation (central repository) configured to store all inspection data, which includes transformer signals. In some embodiments, the system is configured to provide training to inspectors to insure consistent inspection results. FIG. 28 shows a system asset data foundation concept according to some embodiments. In some embodiments, the asset data foundation includes one or more of spatial and/or as-built data; asset failure data; asset condition data; work management and/or grid planning; asset operational data; and external environment data.

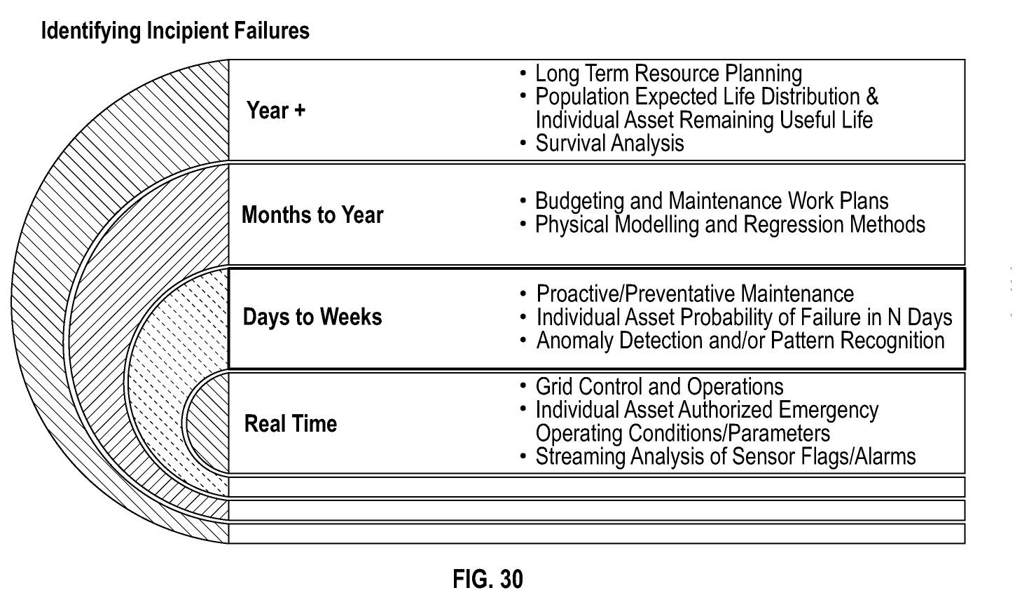

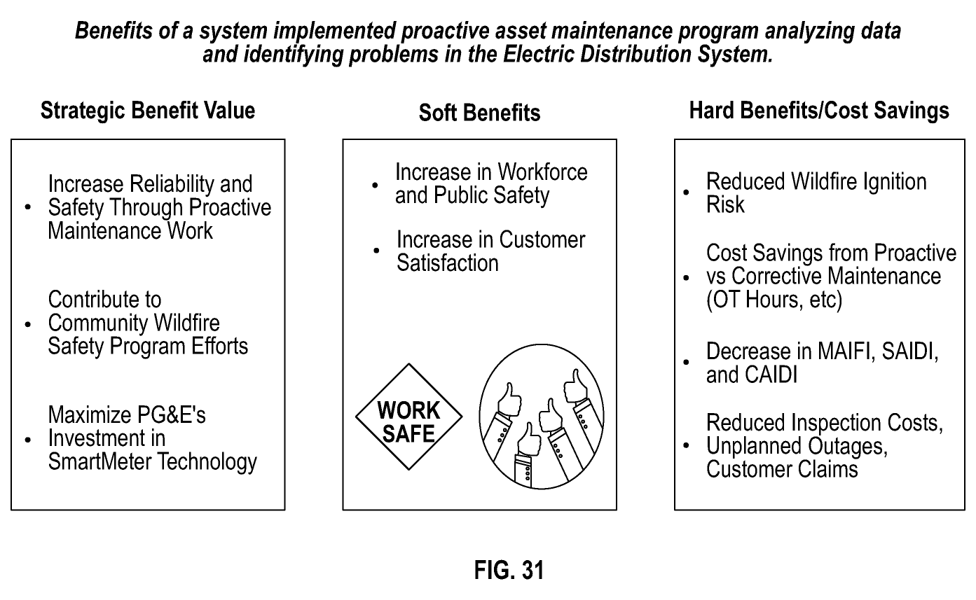

FIGS. 29-31 depict data analytics executed by the system for predictive maintenance according to some embodiments. FIG. 29 shows one or more components of the system’s data analytics platform according to some embodiments. In some embodiments, the system is configured to input data from one or more data sources into the AI model. In some embodiments, one or more data sources include one or more of data (e.g., transformer signals) from the AMI assets, data received by a supervisory and data acquisition system (SCADA), gas insulated substation (GIS) data, senior authorized person (SAP) data, historical asset failures, and outage data, as non-limiting examples. FIG. 30 illustrates the system’s ability to predict a wide timeframe of incipient failures according to some embodiments. In some embodiments, the system is configured to generate one or more actions based on a predicted failure. In some embodiments, the one or more actions include scheduling maintenance, rerouting electricity, ordering of replacement parts and/or assets, generating reports and/or initiating replacement of assets predicted to fail within a specified timeframe. FIG. 31 list various benefits provided by the system’s predictive maintenance implementation according to some embodiments.

FIG. 32 shows a diagram of some assets (components) and terms used in the system according to some embodiments. In some embodiments, each service point meter (sp) represents an electrical meter which may be a smart meter configured to transmit electrical data. In some embodiments, electrical data includes one or more voltage, current, phase, power factor, and/or any conventional meter reading. FIG. 32 illustrates the concept of using multiple meters to determine a transformer’s operational status according to some embodiments. In some embodiments, the system is configured to analyze the data from the one or more smart meters, where each of the one or more smart meters represent a transformer signal. In some embodiments, the system is configured to output a transformer data that includes the analysis.

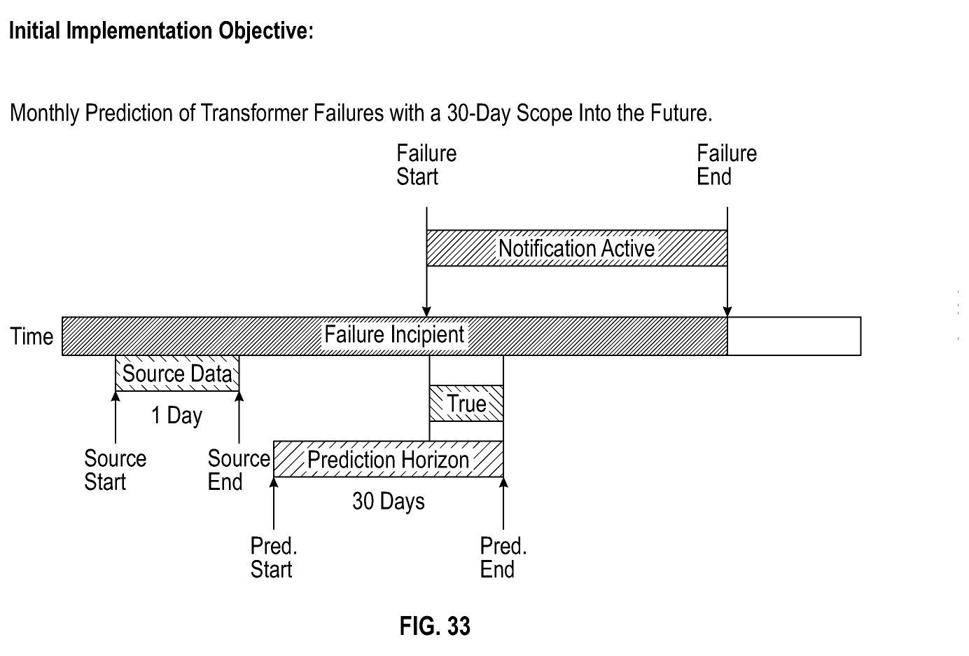

FIG. 33 shows system objectives for initial implementations by a utility according to some embodiments. In some embodiments, the system is configured to be initially trained with historical source data. In some embodiments, the system is configured to compare operational data during an initial monitoring period (prediction horizon). In some embodiments, when the asset data trend statistically matches the model (true), the system is configured to begin generating period notifications. In some embodiments, the periodic notifications include a useful life estimate. In some embodiments, the periodic notifications include one or more charts, graphs, and/or statistical analysis comprising data from one or more sensors mentioned herein.

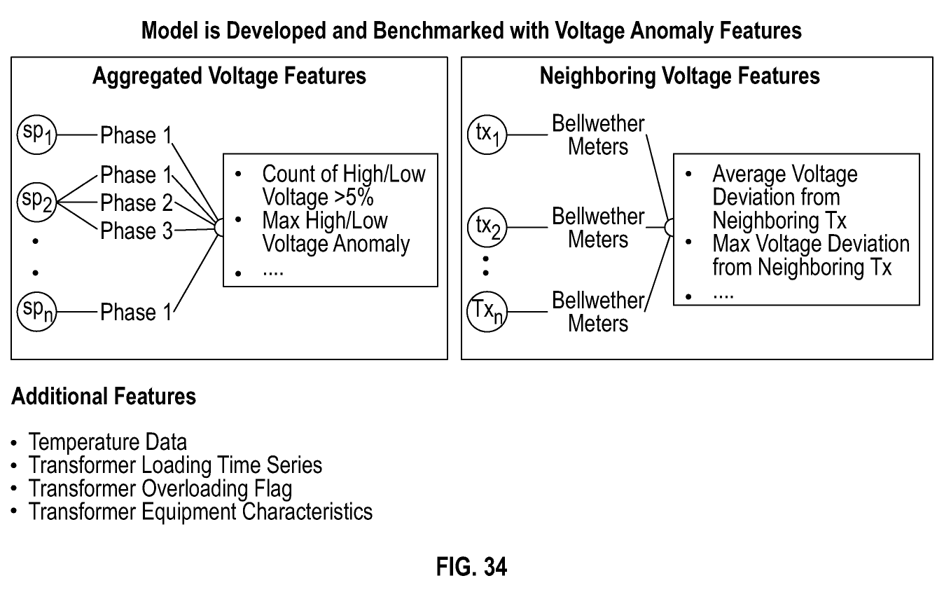

FIG. 34 illustrates how a model is developed and benchmarked with voltage anomaly features according to some embodiments. Referring back to FIG. 32, in some embodiments each sp may comprise one or more phases. In some embodiments, as discussed herein, aggregation of sp data is used to derive a statistical representative transformer signal for a given transformer. In some embodiments, the system is configured to use transformer signals from upstream transformers (bellwether meters) and/or downstream transformers (bellwether meters) as bellwether signals for a particular transformer. In some embodiments, the system is configured to execute a computer implement step of obtaining one or more bellwether signals and/or sending the bellwether signals to the AI model for analysis.

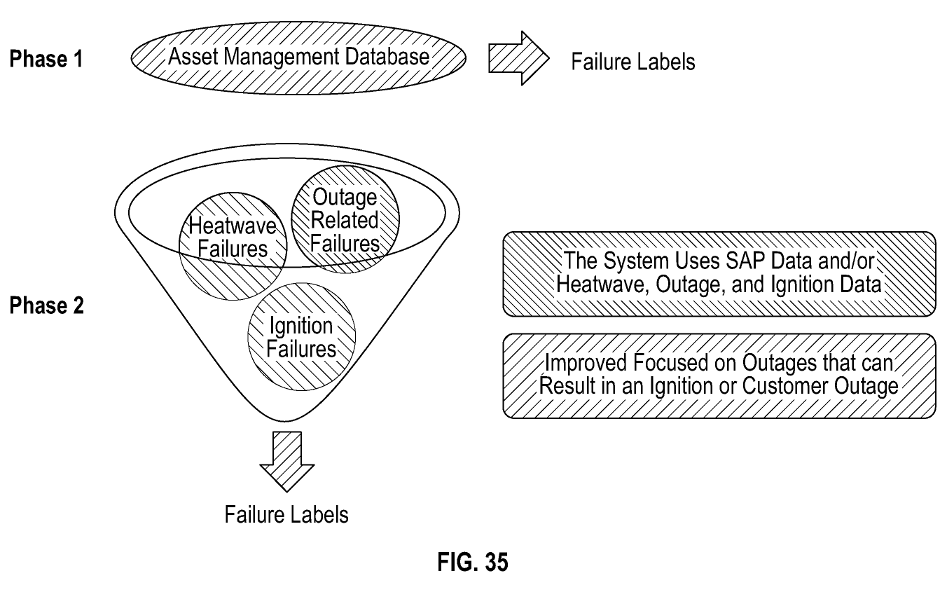

FIG. 35 shows different system phase implementations according to some embodiments. In some embodiments, the system is configured to enable a user to label a failure as one or more of a heatwave failure, an outage related failure, and an ignition failure. In some embodiments, the AI model is configured to indicate if a failure is likely (above a pre-determined threshold value; statistically) to result in an outage and/or ignition (fire). In some embodiments, the system is configured to suggest new power routing around assets that require maintenance and/or have a high probability of failure, including those that would cause outage and/or ignition.

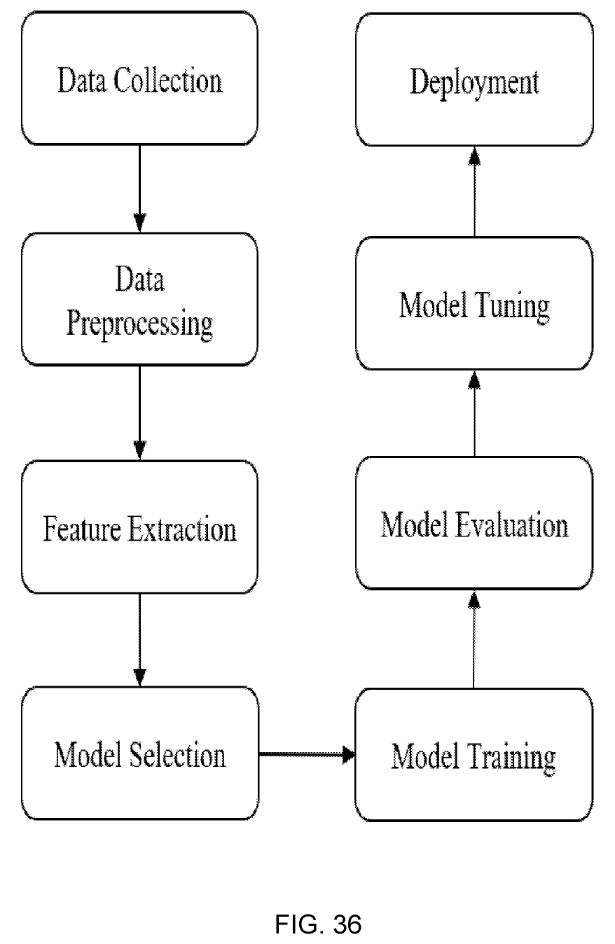

FIG. 36 illustrates the various steps for building an AI model to implement one or more aspects of the system according to some embodiments.

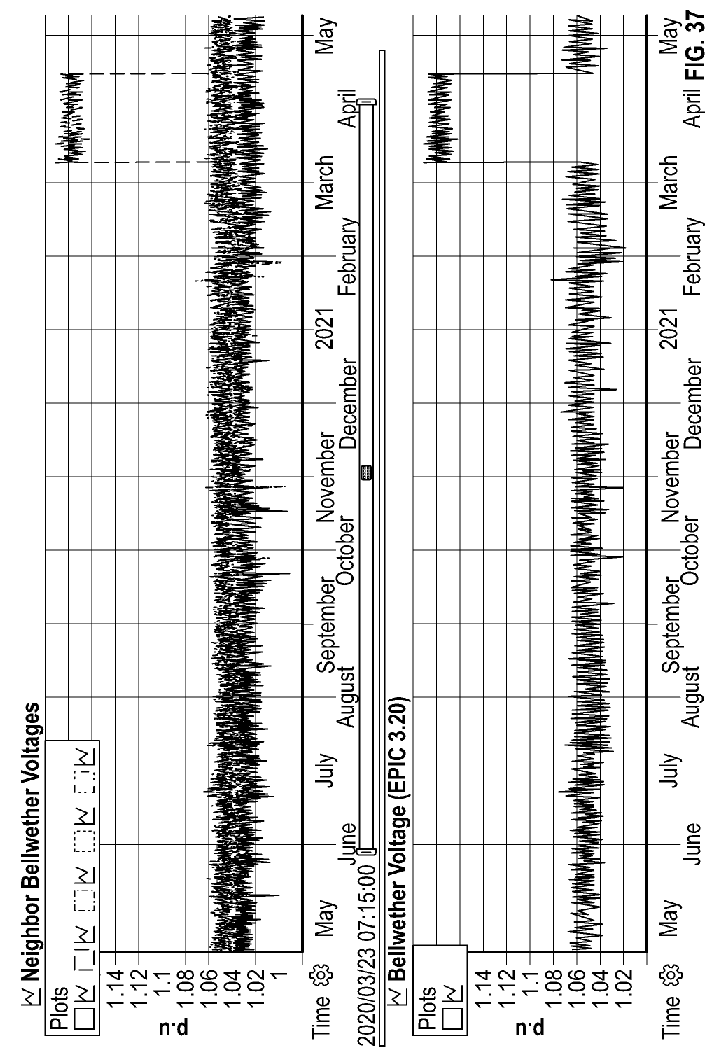

FIG. 37 shows system identification of a potential windings failure after a lightning event according to some embodiments.

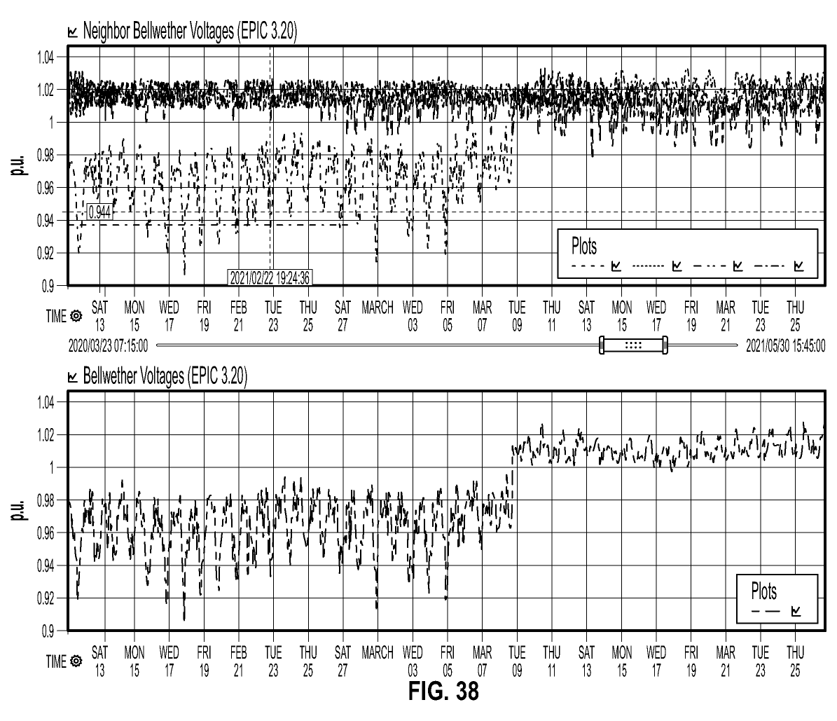

FIG. 38 shows a system identification of a potential non-technical loss that may lead to transformer overloading due to un-metered energy use according to some embodiments.

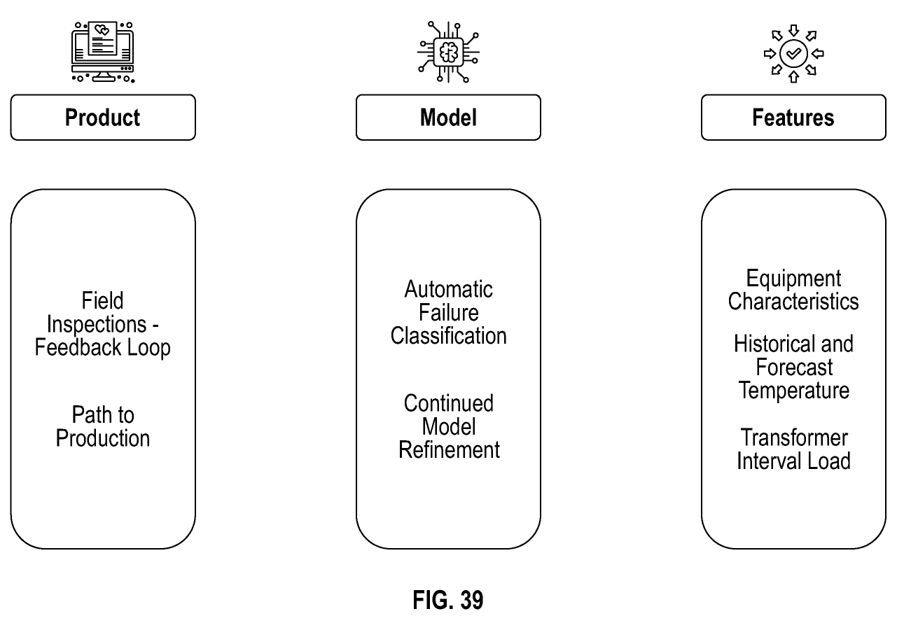

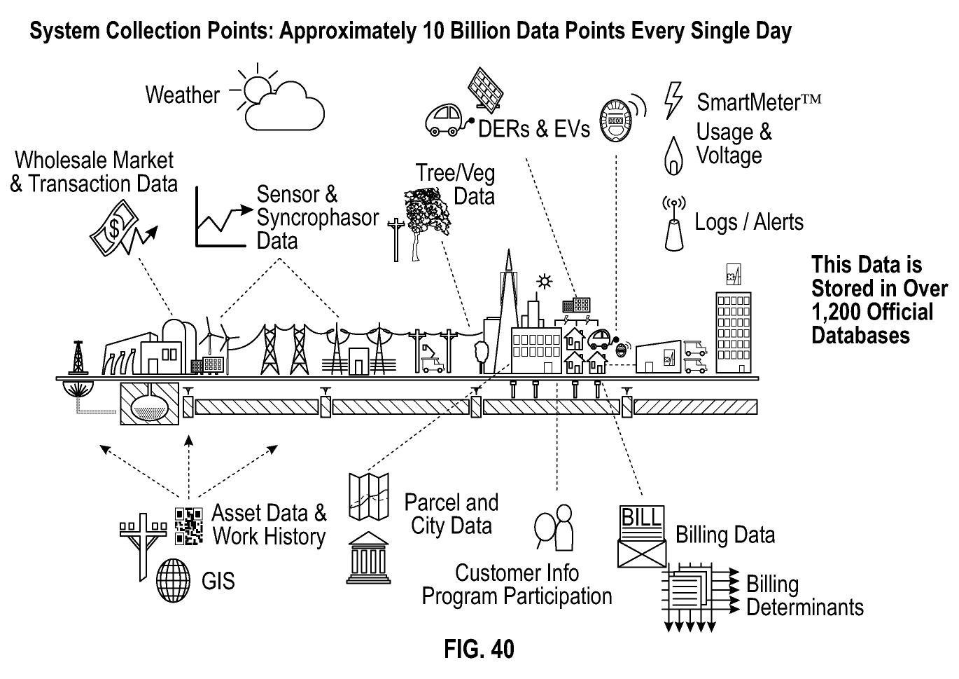

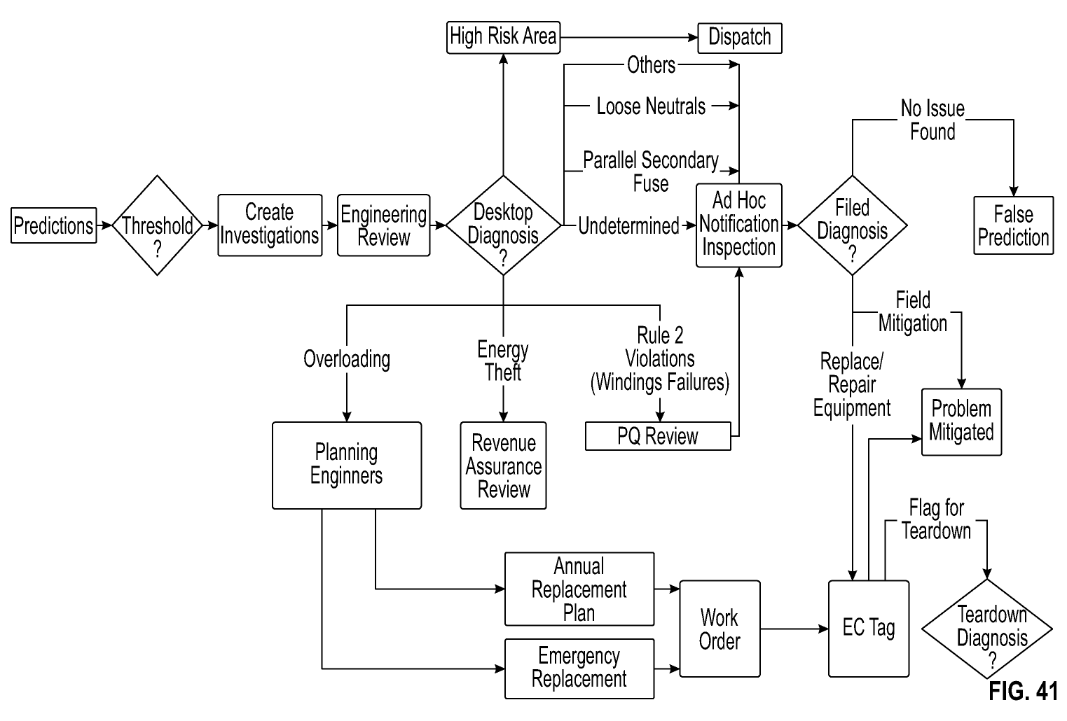

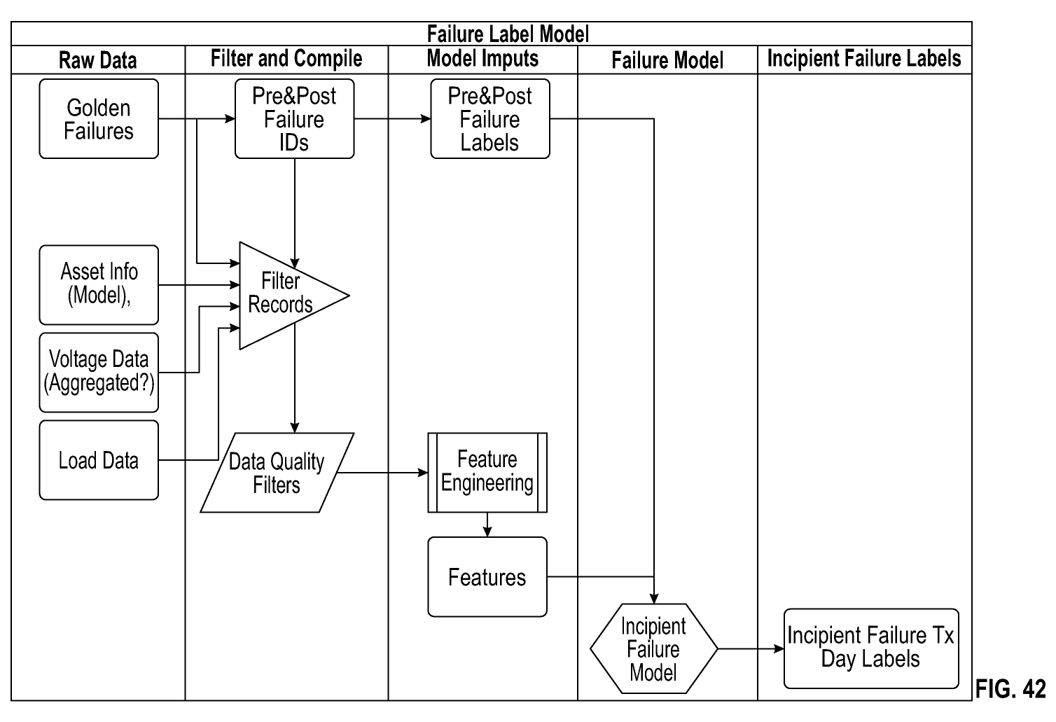

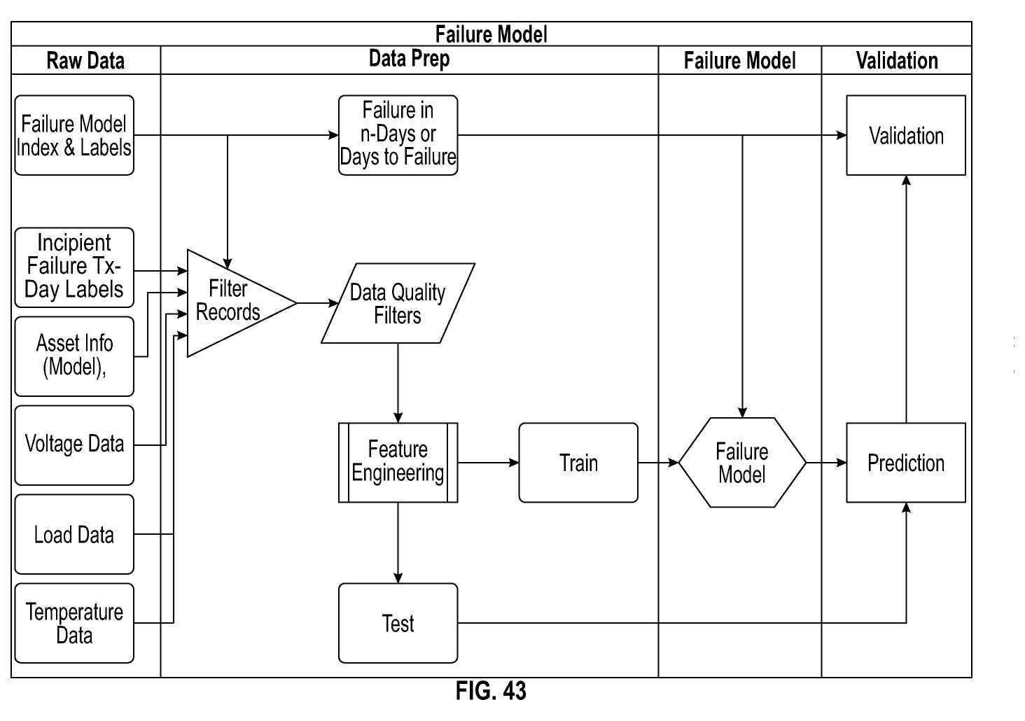

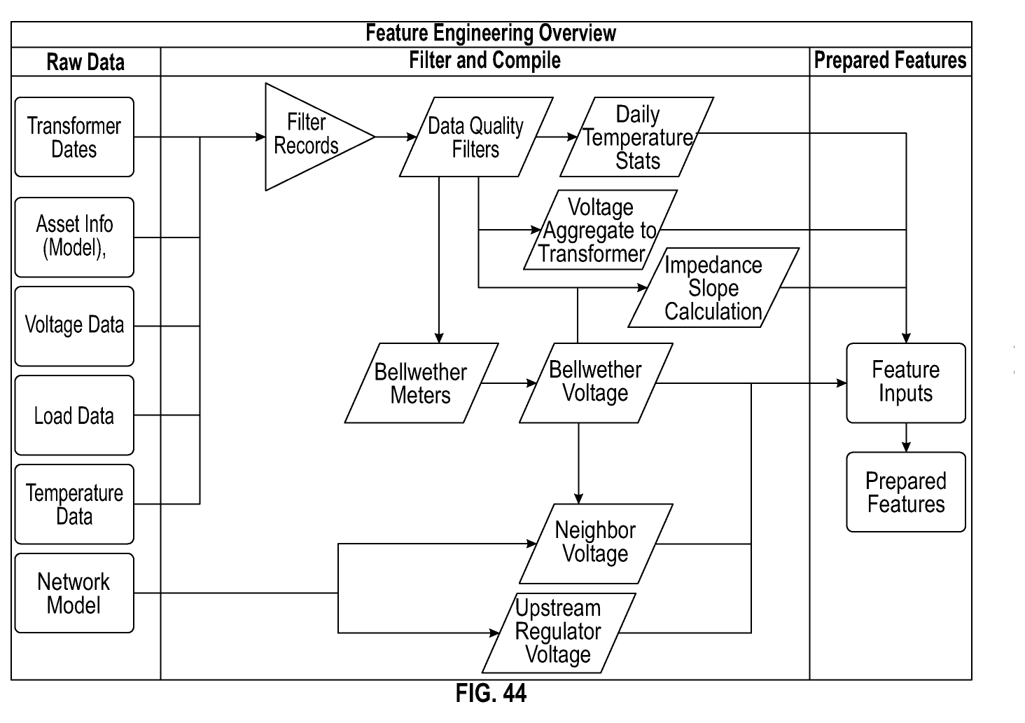

FIG. 39 shows steps for system implementation and refinement by a utility according to some embodiments. FIG. 40 shows various subsystems that the system uses to collect data inputs according to some embodiments. FIG. 41 shows a flowchart for implementing corrective action for various types of identified anomalies according to some embodiments. FIG. 42 shows a flowchart for creating transformer incipient failure day labels. FIG. 43 shows inputting transformer incipient failure day labels for prediction and validation. FIG. 44 shows filtering and compiling to generate prepared features according to some embodiments.

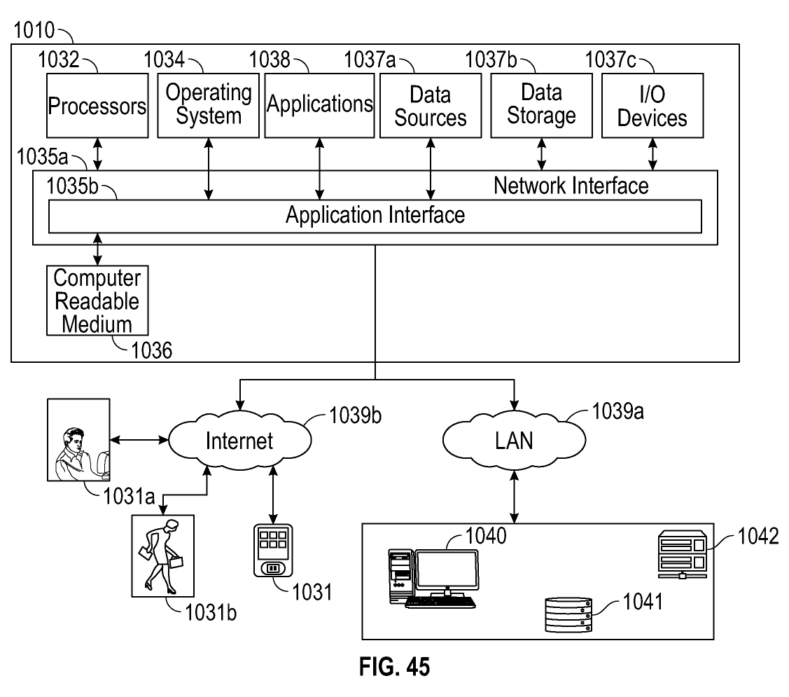

FIG. 45 illustrates a computer system 1010 enabling or comprising the systems and methods in accordance with some embodiments of the system. In some embodiments, the computer system 1010 can operate and/or process computer-executable code of one or more software modules of the aforementioned system and method. Further, in some embodiments, the computer system 1010 can operate and/or display information within one or more graphical user interfaces (e.g., HMIs) integrated with or coupled to the system.

In some embodiments, the computer system 1010 can comprise at least one processor 1032. In some embodiments, the at least one processor 1032 can reside in, or coupled to, one or more conventional server platforms (not shown). In some embodiments, the computer system 1010 can include a network interface 1035a and an application interface 1035b coupled to the least one processor 1032 capable of processing at least one operating system 1034. Further, in some embodiments, the interfaces 1035a, 1035b coupled to at least one processor 1032 can be configured to process one or more of the software modules (e.g., such as enterprise applications 1038). In some embodiments, the software application modules 1038 can include server-based software and can operate to host at least one user account and/or at least one client account, and operate to transfer data between one or more of these accounts using the at least one processor 1032.

With the above embodiments in mind, it is understood that the system can employ various computer-implemented operations involving data stored in computer systems. Moreover, the above-described databases and models described throughout this disclosure can store analytical models and other data on computer-readable storage media within the computer system 1010 and on computer-readable storage media coupled to the computer system 1010 according to various embodiments. In addition, in some embodiments, the above-described applications of the system can be stored on computer-readable storage media within the computer system 1010 and on computer-readable storage media coupled to the computer system 1010. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 1010 can comprise at least one computer readable medium 1036 coupled to at least one of at least one data source 1037a, at least one data storage 1037b, and/or at least one input/output 1037c. In some embodiments, the computer system 1010 can be embodied as computer readable code on a computer readable medium 1036. In some embodiments, the computer readable medium 1036 can be any data storage that can store data, which can thereafter be read by a computer (such as computer 1040). In some embodiments, the computer readable medium 1036 can be any physical or material medium that can be used to tangibly store the desired information or data or instructions and which can be accessed by a computer 1040 or processor 1032. In some embodiments, the computer readable medium 1036 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 1036 can transmit or carry instructions to a remote computer 1040 and/or at least one user 1031, including a router, private or public network, or other transmission or channel, both wired and wireless. In some embodiments, the software application modules 1038 can be configured to send and receive data from a database (e.g., from a computer readable medium 1036 including data sources 1037a and data storage 1037b that can comprise a database), and data can be received by the software application modules 1038 from at least one other source. In some embodiments, at least one of the software application modules 1038 can be configured within the computer system 1010 to output data to at least one user 1031 via at least one graphical user interface rendered on at least one digital display.

In some embodiments, the computer readable medium 1036 can be distributed over a conventional computer network via the network interface 1035a where the system embodied by the computer readable code can be stored and executed in a distributed fashion. For example, in some embodiments, one or more components of the computer system 1010 can be coupled to send and/or receive data through a local area network (“LAN”) 1039a and/or an internet coupled network 1039b (e.g., such as a wireless internet). In some embodiments, the networks 1039a, 1039b can include wide area networks (“WAN”), direct connections (e.g., through a universal serial bus port), or other forms of computer-readable media 1036, or any combination thereof.

In some embodiments, components of the networks 1039a, 1039b can include any number of personal computers 1040 which include, for example desktop computers, and/or laptop computers, or any fixed, generally non-mobile internet appliances coupled through the LAN 1039a. For example, some embodiments include one or more of personal computers 1040, databases 1041, and/or servers 1042 coupled through the LAN 1039a that can be configured for any type of user including an administrator. Some embodiments can include one or more personal computers 1040 coupled through network 1039b. In some embodiments, one or more components of the computer system 1010 can be coupled to send or receive data through an internet network (e.g., such as network 1039b). For example, some embodiments include at least one user 1031a, 1031b, is coupled wirelessly and accessing one or more software modules of the system including at least one enterprise application 1038 via an input and output (“I/O”) 1037c. In some embodiments, the computer system 1010 can enable at least one user 1031a, 1031b, to be coupled to access enterprise applications 1038 via an I/O 1037c through LAN 1039a. In some embodiments, the user 1031 can comprise a user 1031a coupled to the computer system 1010 using a desktop computer, and/or laptop computers, or any fixed, generally non-mobile internet appliances coupled through the internet 1039b. In some embodiments, the user can comprise a mobile user 1031b coupled to the computer system 1010. In some embodiments, the user 1031b can connect using any mobile computing 1031c to wireless coupled to the computer system 1010, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of predictive maintenance by using artificial intelligence including data collection and machine learning to identify anomalies indicative of failure in components that are part of a utility grid. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system’s disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. It is understood that defining the metes and bounds of the system using a description of images in the drawing does not need a corresponding text description in the written specification to fall with the scope of the disclosure.

Furthermore, acting as Applicant’s own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, which can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules, or other data.

As used herein, reference to method steps is also a reference to computer implemented steps according to some embodiments. Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system for predicting asset failure and classifying failure modes in an electrical distribution system comprising:
an asset,
one or more electrical meters,
an AI model comprising a failure prediction model, and
one or more computers comprising one or more processors and one or more non-transitory computer readable media, the one or more non-transitory computer readable media including program instructions stored thereon that when executed cause the one or more computers to:
receive meter data from the one or more electrical meters;
associate the meter data with the asset to create asset data;
determine, by the failure prediction model, a probability of failure of the asset based on the asset data.

2. The system of claim 1,
wherein the one or more non-transitory computer readable media including program instructions stored thereon that when executed cause the one or more computers to:
determine, by a failure mode classification model, a predicted root cause classification of the asset based on the asset data.

3. The system of claim 2,
where the failure mode classification model is configured to receive the probability of failure from the failure prediction model before determining the predicted root cause classification.

4. The system of claim 2,
wherein the predicted root cause classification comprises one or more root cause categories.

5. The system of claim 4,
wherein the one or more root cause categories comprise one or more of windings failure, loose neutral, overloading, energy theft, ignition failure, and heatwave failure.

6. The system of claim 2,
wherein the failure mode classification model receives the asset data for the asset after the failure prediction model determines the probability of failure exceeds a threshold.

7. The system of claim 2,
wherein the system is configured to generate a graphical user interface displaying the predicted root cause classification.

8. The system of claim 7,
wherein the system is configured to receive a user correction to the predicted root cause classification via the graphical user interface.

9. The system of claim 8,
wherein the system is configured to send the user correction to the failure mode classification model to improve classification accuracy.

10. The system of claim 2,
wherein the system is configured to combine the probability of failure with the predicted root cause classification to generate a composite priority score.

11. The system of claim 1,
wherein the probability of failure comprises an insulation degradation assessment.

12. The system of claim 11,
wherein the insulation degradation assessment is based on an aggregated loading percentage, one or more temperature-related features, and/or a transformer age.

13. The system of claim 1,
wherein the asset data comprises a number of consecutive days during which ambient temperature exceeds a specified threshold.

14. The system of claim 13,
wherein the asset data comprises an estimated air conditioning demand based on an average daily temperature.

15. The system of claim 14,
wherein the asset comprises a transformer.

16. The system of claim 2,
wherein the asset data comprises a geographic designation.

17. The system of claim 2,
wherein the failure prediction model is trained with transformer data labeled as failure or non-failure.

18. The system of claim 17,
wherein the failure mode classification model is trained with transformer data labeled with a root cause designation.
